(19) United States
(12) Patent Application Publication
(10) Pub. No.: US 2025/0184013 A1
(43) Pub. Date: Jun. 5, 2025

(54) CALIBRATION METHOD AND APPARATUS, INFORMATION TRANSMISSION METHOD AND APPARATUS, AND COMMUNICATION DEVICE

(71) Applicant: VIVO MOBILE COMMUNICATION CO., LTD., Dongguan (CN)

(72) Inventors: Jianzhi LI, Dongguan (CN); Baolong CHEN, Dongguan (CN); Dajie JIANG, Dongguan (CN); Jian YAO, Dongguan (CN)

(73) Assignee: VIVO MOBILE COMMUNICATION CO., LTD., Dongguan (CN)

(21) Appl. No.: 19/050,069

(22) Filed: Feb. 10, 2025

Related U.S. Application Data
(63) Continuation of application No. PCT/CN2023/111427, filed on Aug. 7, 2023.

(30) Foreign Application Priority Data
Aug. 12, 2022 (CN) 202210968980.9

(51) Int. Cl. H04B 17/21; H04B 7/06; H04B 17/10; H04W 52/36

(52) U.S. Cl. CPC H04B 17/21; H04B 7/0626; H04B 17/104; H04W 52/367

(57) ABSTRACT

This application discloses a calibration method and apparatus, an information transmission method and apparatus, and a communication device. The calibration method includes: obtaining, by a first node, first information, and obtaining a first measurement value, where the first information is used to indicate a non-ideal factor existing when at least one sensing node executes a first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value; and performing, by the first node, calibration processing on the first measurement value based on the first information, to obtain a second measurement value, where a sensing result of the first service is determined based on the second measurement value.

### CROSS-REFERENCE TO RELATED APPLICATIONS

This application is a continuation of International Application No. PCT/CN2023/111427, filed Aug. 7, 2023, which claims priority to Chinese Patent Application No. 202210968980.9, filed Aug. 12, 2022. The entire contents of each of the above-referenced applications are expressly incorporated herein by reference.

### TECHNICAL FIELD

This application pertains to the field of communication technologies, and specifically relates to a calibration method and apparatus, an information transmission method and apparatus, and a communication device.

### BACKGROUND

In a related technology, a sensing node in a mobile communication network may send and receive a sensing signal to implement sensing measurement on a status of a sensing target or a sensing environment. However, a sensing measurement result is affected by non-ideal factors such as a hardware defect of the sensing node, a hardware difference between sensing nodes, and an information processing difference between sensing nodes, causing a relatively large error in the sensing result, and even making it impossible to execute a sensing/integrated sensing and communication service.

### SUMMARY

Embodiments of this application provide a calibration method and apparatus, an information transmission method and apparatus, and a communication device, so that a measurement value obtained through sensing measurement can be calibrated based on information related to a non-ideal factor of a sensing node participating in sensing, to reduce a deviation between a measurement value obtained after calibration and a true value, so as to improve accuracy of a sensing result obtained based on the measurement value obtained after calibration, and improve sensing performance.

According to a first aspect, a calibration method is provided. The method includes:
obtaining, by a first node, first information, and obtaining a first measurement value, where the first information is used to indicate a non-ideal factor existing when at least one sensing node executes a first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value; and
performing, by the first node, calibration processing on the first measurement value based on the first information, to obtain a second measurement value, where a sensing result of the first service is determined based on the second measurement value.

According to a second aspect, a calibration apparatus is provided and applied to a first node. The apparatus includes:
a first obtaining module, configured to: obtain first information, and obtain a first measurement value, where the first information is used to indicate a non-ideal factor existing when at least one sensing node executes a first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value; and
a calibration module, configured to perform calibration processing on the first measurement value based on the first information, to obtain a second measurement value, where a sensing result of the first service is determined based on the second measurement value.

According to a third aspect, an information transmission method is provided. The method includes:
sending, by a second node, first information to a first node, where the first information is used to indicate a non-ideal factor existing when at least one sensing node executes a first service, the first information is used to calibrate a first measurement value of the first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value.

According to a fourth aspect, an information transmission apparatus is provided and applied to a second node. The apparatus includes:
a first sending module, configured to send first information to a first node, where the first information is used to indicate a non-ideal factor existing when at least one sensing node executes a first service, the first information is used to calibrate a first measurement value of the first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value.

According to a fifth aspect, a communication device is provided. The communication device includes a processor and a memory. The memory stores a program or instructions capable of being run on the processor, and when the program or the instructions are executed by the processor, the steps of the method according to the first aspect or the third aspect are implemented.

According to a sixth aspect, a communication device is provided and includes a processor and a communication interface.

In a case in which the communication device is a first node, the communication interface is configured to: obtain first information, and obtain a first measurement value, where the first information is used to indicate a non-ideal factor existing when at least one sensing node executes a first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value; and the processor is configured to perform calibration processing on the first measurement value based on the first information, to obtain a second measurement value, where a sensing result of the first service is determined based on the second measurement value.

In a case in which the communication device is a second node, the communication interface is configured to send first information to a first node, where the first information is used to indicate a non-ideal factor existing when at least one sensing node executes a first service, the first information is used to calibrate a first measurement value of the first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value.

According to a seventh aspect, a readable storage medium is provided. The readable storage medium stores a program or instructions, and when the program or the instructions are executed by a processor, the steps of the method according to the first aspect or the third aspect are implemented.

According to an eighth aspect, a chip is provided. The chip includes a processor and a communication interface. The communication interface is coupled to the processor. The processor is configured to run a program or instructions to implement the method according to the first aspect or the third aspect.

According to a ninth aspect, a computer program/program product is provided. The computer program/program product is stored in a storage medium. The computer program/program product is executed by at least one processor to implement the steps of the method according to the first aspect or the third aspect.

In the embodiments of this application, the first node obtains the first information, and obtains the first measurement value, where the first information is used to indicate the non-ideal factor existing when the at least one sensing node executes the first service, the first service includes the sensing service or the integrated sensing and communication service, and the non-ideal factor includes the factor causing at least one of the frequency deviation, the time deviation, the power deviation, the amplitude deviation, or the phase deviation between the first measurement value and the true value; and the first node performs calibration processing on the first measurement value based on the first information, to obtain the second measurement value, where the sensing result of the first service is determined based on the second measurement value. In this way, the first node can calibrate, based on a non-ideal factor of the sensing node of the first service, the first measurement value obtained through sensing measurement, to reduce a deviation between the second measurement value obtained after calibration and the true value, so as to improve accuracy of the sensing result obtained based on the second measurement value, and improve sensing performance.

### BRIEF DESCRIPTION OF DRAWINGS

FIG. 1 is a schematic diagram of a structure of a wireless communication system to which an embodiment of this application can be applied;

FIG. 2 is a flowchart of a calibration method according to an embodiment of this application;

FIG. 3a is a schematic diagram of a first sensing manner;

FIG. 3b is a schematic diagram of a second sensing manner;

FIG. 4 is a flowchart of an information transmission method according to an embodiment of this application;

FIG. 5 is a schematic diagram of a structure of a calibration apparatus according to an embodiment of this application;

FIG. 6 is a schematic diagram of a structure of an information transmission apparatus according to an embodiment of this application; and

FIG. 7 is a schematic diagram of a structure of a communication device according to an embodiment of this application.

### DETAILED DESCRIPTION

The technical solutions in the embodiments of this application are clearly described below with reference to the accompanying drawings in the embodiments of this application. Clearly, the described embodiments are some but not all of the embodiments of this application. All other embodiments obtained by a person of ordinary skill in the art based on the embodiments of this application shall fall within the protection scope of this application.

The terms “first”, “second”, and the like in the specification and the claims of this application are used to distinguish between similar objects, and are not used to describe a specific sequence or order. It should be understood that the terms used in such a manner are interchangeable in proper situations, so that the embodiments of this application can be implemented in a sequence other than those illustrated or described herein. In addition, objects distinguished by using “first” and “second” are usually of a same type, and a quantity of objects is not limited. For example, there may be one or more first objects. Furthermore, in the specification and the claims, “and/or” indicates at least one of connected objects, and the character “/” usually indicates an “or” relationship between associated objects.

It should be noted that the technologies described in the embodiments of this application are not limited to a Long Term Evolution (LTE)/LTE-Advanced (LTE-A) system, and may be further used in other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and another system. The terms “system” and “network” in the embodiments of this application are often interchangeably used. The described technologies may be used in the systems and radio technologies described above, and may be further used in other systems and radio technologies. A New Radio (NR) system is described in the following descriptions for example purposes, and NR terms are used in most of the following descriptions. However, these technologies may be further applied to applications other than NR system applications, for example, a 6^{th} Generation (6G) communication system.

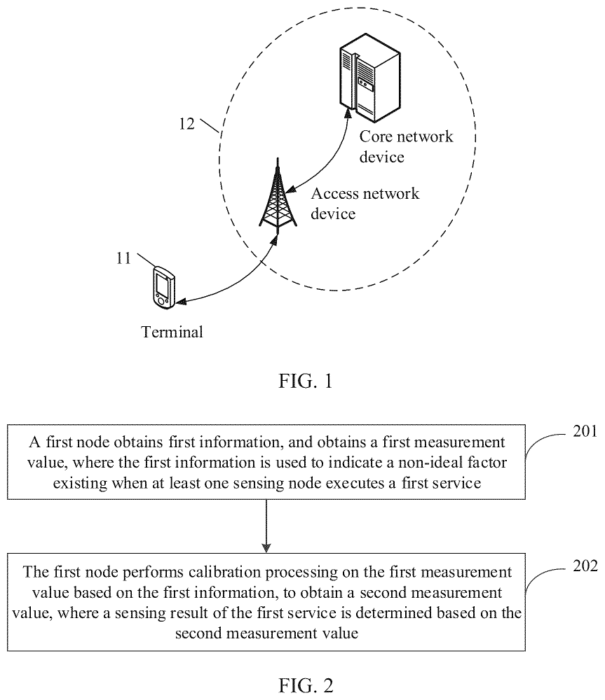

FIG. 1 is a block diagram of a wireless communication system to which an embodiment of this application may be applied. The wireless communication system includes a terminal 11 and a network side device 12. The terminal 11 may be a mobile phone, a tablet personal computer, a laptop computer, or referred to as a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, a vehicle-mounted device (VUE), a Pedestrian User Equipment (PUE), a smart home (a home device with a wireless communication function, for example, a refrigerator, a television, a washing machine, or a piece of furniture), a game console, a personal computer (PC), a teller machine, a self-service machine, or another terminal side device. The wearable device includes a smartwatch, a smart band, a smart headset, smart glasses, smart jewelry (a smart bracelet, a smart hand chain, a smart ring, a smart necklace, a smart anklet, a smart foot chain, or the like), a smart wristband, smart clothing, or the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another proper term in the field. Provided that same technical effects are achieved, the base station is not limited to a specific technical vocabulary. It should be noted that in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a local NEF (L-NEF), a Binding Support Function (BSF), an Application Function (AF), or the like. It should be noted that in the embodiments of this application, only a core network device in the NR system is used as an example for description, and a specific type of the core network device is not limited.

Wireless communication and radar sensing (Communication&Sensing, C&S) have been developing in parallel but with a limited intersection. Wireless communication and radar sensing share many commonalities in terms of a signal processing algorithm, a device, and a system architecture to some extent. In recent years, conventional radar is developing towards more general-purpose wireless sensing. Wireless sensing may broadly mean to retrieve information from a received radio signal. For wireless sensing related to sensing of a target location, a reflection delay, an angle of arrival, an angle of departure, Doppler, and other dynamic parameters of a target signal may be estimated by using a common signal processing method. A target physical feature may be sensed by measuring an inherent signal pattern of a device/object/activity. The two sensing manners may be respectively referred to as sensing parameter estimation and pattern recognition. In this sense, wireless sensing refers to more general-purpose sensing technologies and applications using radio signals.

Integrated sensing and communication (ISAC) has the potential to integrate wireless sensing into large-scale mobile networks, which are referred to as Perceptive Mobile Networks (PMNs) herein. The perceptive mobile networks can provide both communication and wireless sensing services, and are expected to become a ubiquitous wireless sensing solution because of relatively extensive broadband coverage and robust infrastructure of the perceptive mobile networks. The perceptive mobile networks may be widely applied to communication and sensing in the fields of transportation, communication, energy, precision agriculture, and security. The perceptive mobile networks may further provide complementary sensing capabilities to existing sensor networks, have unique day and night operation functions, and can penetrate fog, leaves, and even solid objects. Some common sensing services are shown in Table 1 below:

TABLE 1

| Physical | Real-time | | |
|---|---|---|---|
| sensing | sensing | | |
| range | requirement | Sensing function | Application uses |
| Large | Medium | Weather, air quality, | Meteorology, agriculture, |
| | | and the like | and life services |
| Large | Medium | Traffic flow (roads) | Smart city, smart |
| | | and crowd flow | transportation, and |
| | | (subway stations) | commercial services |
| Large | Medium | Animal activity and | Animal husbandry, |
| | | migration, and the | ecological environment |
| | | like | protection, and the like |
| Large | High | Target tracking, | Many application |
| | | ranging, speed | scenarios of conventional |
| | | measurement, and | radar, vehicle wireless |
| | | angle measurement | communication |
| | | | technologies (Vehicle to |
| | | | X, V2X), and the like |
| Large | Low | Three-dimensional | Navigation and smart |
| | | map construction | city |
| Small | High | Action and posture | Smart interaction of |
| | | recognition | smartphones, games, and |
| | | | smart home |
| Small | High | Heartbeat/breathing | Health monitoring and |
| | | and the like | medical care |
| Small | Medium | Imaging | Security check and |
| | | | logistics |
| Physical | Real-time | Sensing function | Application uses |
| sensing | sensing | | |
| range | requirement | | |
| Small | Low | Material | Construction, |
| | | | manufacturing, |
| | | | exploration, and the like |

In integrated sensing and communication, it is particularly important to obtain accurate measurement information, and non-ideal factors of a component and a hardware circuit of a node participating in a sensing service significantly affect measurement accuracy. For example, in a sensing manner of sending and receiving between a base station and a terminal, extracting Channel State Information (CSI) for sensing is a main implementation of integrated sensing and communication. In this process, it is particularly important to obtain a sensing channel with relatively good quality. However, some non-ideal factors cause a CSI measurement error, significantly affecting sensing accuracy.

For example, impact of a receiving node on the CSI may include the following:
(1) Power Amplifier Uncertainty (PAU) or uncertainty in signal received power: Because components such as a Low Noise Amplifier (LNA) and a Programmable Gain Amplifier (PGA) are not ideal, actual gain adjustment does not meet an expectation, and consequently a CSI amplitude obtained through measurement is inaccurate.
(2) In-phase (I) and quadrature (Q) imbalance: Due to limitations in performance of I and Q branch components, a strict phase difference of 90° of a local oscillator signal cannot be ensured, and there is a gain difference between two signals, a direct current bias, and the like. Consequently, orthogonality of a baseband signal is destroyed, causing degradation of the CSI.
(3) Time-frequency synchronization deviation: Factors such as a clock deviation and non-ideal synchronization between a transmitting node and the receiving node cause problems such as a carrier frequency offset, a sampling frequency offset, and a symbol timing offset, and this affects accuracy of speed estimation or causes ranging ambiguity.
(4) Antenna/Array amplitude and phase errors: This includes the following: When sensing is performed by using beamforming, beamforming amplitude and phase errors cause a case in which a formed beam shape (beam gain, beam width, and sidelobe level) does not match an actual situation. Consequently, when sensing is performed based on channel information after beamforming, there is a reduction in accuracy, and angle and reflected power estimation errors are caused. In addition, a beam switching delay increases impact of interference and noise on a sensing result.

It may be learned from the foregoing that in a related technology, during execution of a sensing/integrated sensing and communication service, non-ideal factors such as a hardware defect of a node participating in sensing, a hardware difference between nodes, and a signal processing difference between nodes cause deterioration of sensing performance, and even make it impossible to execute the sensing/integrated sensing and communication service.

In the embodiments of this application, after a sensing node obtains a first measurement value through measurement, the first measurement value is further calibrated based on a non-ideal factor existing when the sensing node executes a first service, to reduce a deviation between a second measurement value obtained after calibration and a true value. In this way, when a sensing result of the first service is determined based on the second measurement value, accuracy of the sensing result can be improved.

A base station (including one or more Transmission Reception Point (TRP) in the base station) and User Equipment (UE) (including one or more antenna subarrays/panels in the UE) in a mobile communication network may serve as sensing nodes participating in a sensing/integrated sensing and communication service. The sensing node sends and receives a sensing signal, to sense an area or a physical target. The sensing signal may be a signal that does not include transmission information, for example, existing LTE/NR synchronization and reference signals (including a synchronization signal and physical broadcast channel block (Synchronization Signal and PBCH block, SSB) signal, a channel state information (CSI) reference signal (CSI Reference Signal, CSI-RS), a Demodulation Reference Signal (DMRS), a Sounding Reference Signal (SRS), a Positioning Reference Signal (PRS), a Phase Tracking Reference Signal (PTRS), and the like). In some embodiments, the sensing signal may be a single-frequency continuous wave (CW), a frequency modulated continuous wave (Frequency Modulated CW, FMCW), an ultra-wideband Gaussian pulse, and the like commonly used in radar. In addition, the sensing signal may be a newly designed dedicated sensing signal with a good correlation characteristic and peak-to-average power ratio (PAPR), or a newly designed integrated sensing and communication signal that carries specific information and has relatively good sensing performance. For example, the new signal is formed by concatenating/combining/superimposing at least one dedicated sensing signal/reference signal and at least one communication signal in time domain and/or frequency domain. A type of the sensing signal is not specifically limited herein. For ease of description, the foregoing signals are collectively referred to as a first signal in the following embodiments.

For ease of description, in the embodiments of this application, nodes that send and/or receive the first signal are collectively referred to as a sensing node.

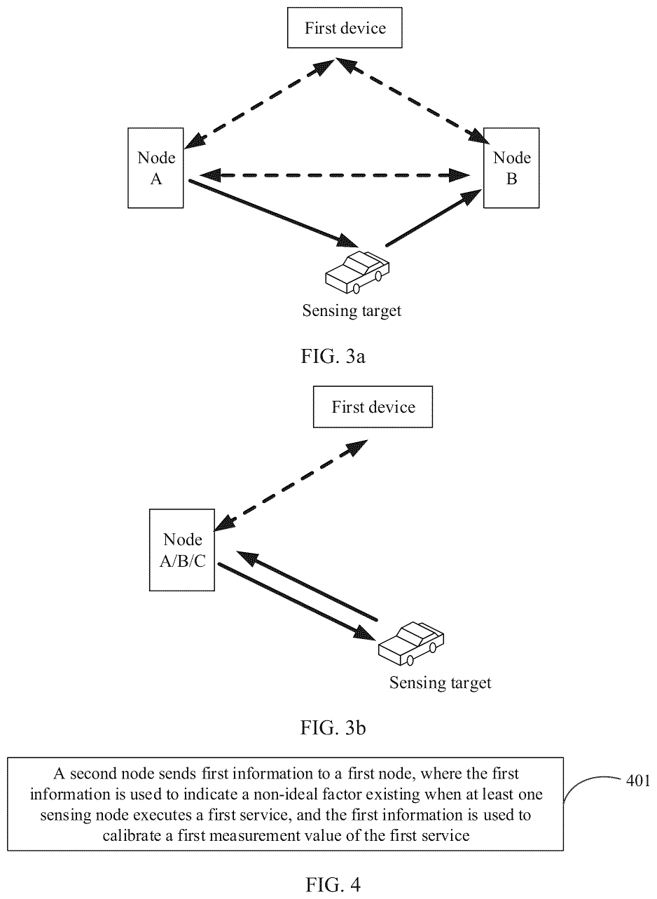

In the embodiments of this application, sensing manners are classified into a first sensing manner and a second sensing manner based on whether a transmitting node and a receiving node of the sensing signal are a same device. As shown in FIG. 3a, in the first sensing manner, a sensing node A sends the first signal, and a sensing node B receives the first signal. The sensing node A and the sensing node B are not a same device, and are physically separated. As shown in FIG. 3b, in the second sensing manner, a same sensing node (A/B/C) sends and receives the first signal, that is, the sensing signal is sent and received by a same device, and the sensing node performs sensing by receiving an echo of the signal sent by the sensing node.

It should be noted that the first device shown in FIG. 3a and FIG. 3b may be a core network device, for example, a Sensing Function (SF) network element in a core network, an Access and Mobility Management Function (AMF), or a sensing application server in a core network.

In addition, in the embodiments of this application, there may be one or at least two signal transmitting nodes and/or signal receiving nodes of the first service. FIG. 3a and FIG. 3b are merely possible examples, and constitute no specific limitation herein.

With reference to the accompanying drawings, the calibration method, the information transmission method, the calibration apparatus, the information transmission apparatus, and the communication device provided in the embodiments of this application are described below in detail by using some embodiments and application scenarios.

With reference to FIG. 2, an embodiment of this application provides a calibration method. The calibration method may be performed by a first node. This is not specifically limited herein.

As shown in FIG. 2, the calibration method provided in this embodiment of this application may include the following steps:
Step 201: The first node obtains first information, and obtains a first measurement value, where the first information is used to indicate a non-ideal factor existing when at least one sensing node executes a first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value.
Step 202: The first node performs calibration processing on the first measurement value based on the first information, to obtain a second measurement value, where a sensing result of the first service is determined based on the second measurement value.

In this embodiment of this application, the first node represents a node that calibrates the first measurement value. A sensing measurement quantity corresponding to the first measurement value includes at least one of the following:
a frequency domain channel response between a signal transmitting node and a signal receiving node of the first service; or
a channel impulse response between the signal transmitting node and the signal receiving node of the first service.

The signal receiving node measures the sensing measurement quantity of the first signal, and there is a deviation between the obtained first measurement value and the true value.

In implementation, the first node may include at least one of a core network device (for example, a sensing network function/sensing network element in a core network), a terminal, or a base station.

In some embodiments, the first node may include at least one of the following:
a signal transmitting node, where the signal transmitting node is configured to send a first signal related to the first service;
a signal receiving node, where the signal receiving node is configured to measure the first signal to obtain the first measurement value; or
a computing node, where the computing node is configured to determine the sensing result of the first service based on the second measurement value.

The signal transmitting node may represent a sensing node that sends a sensing signal. The signal receiving node represents a sensing node that receives the sensing signal to obtain the first measurement value. The computing node represents a node that computes the sensing result of the first service based on the second measurement value.

In a case in which the first node includes the signal transmitting node, the first node may obtain the first measurement value from the signal receiving node. In a case in which the first node includes the signal receiving node, the first node may obtain the first measurement value through sensing measurement. In a case in which the first node includes the computing node, the first node may determine the sensing result of the first service based on the second measurement value obtained after calibration.

It should be noted that the signal transmitting node and the signal receiving node may be a same node. For example, as shown in FIG. 3a, a node A sends the first signal, and measures an echo signal of the first signal, to obtain the first measurement value. In this case, the node A is both the signal transmitting node and the signal receiving node.

In addition, the computing node may be a device in the core network, or may be at least one of the signal transmitting node or the signal receiving node. For example, as shown in FIG. 3b, a node A sends the first signal, and a node B measures the first signal to obtain the first measurement value, calibrates the first measurement value to obtain the second measurement value, and computes the sensing result of the first service based on the second measurement value. In this case, the node B serves as the signal receiving node, the first node, and the computing node.

It should be noted that in implementation, there may be one or at least two sensing nodes of the first service, for example, one signal transmitting node and at least two signal receiving nodes, at least two signal transmitting nodes and at least two signal receiving nodes, at least two signal transmitting nodes and one signal receiving node, or at least one signal transmitting and receiving node. In this case, the first node in this embodiment of this application may be any at least one of the sensing nodes. In some embodiments, the first node may be a first device. Details are not described herein.

In this implementation, at least one of the signal transmitting node, the signal receiving node, or the computing node that executes the first sensing service may be reused to calibrate the first measurement value.

A basis for calibrating the first measurement value may include the non-ideal factor existing when the at least one sensing node executes the first service, for example, a non-ideal factor caused by a hardware structure of the signal transmitting node, a non-ideal factor caused by a hardware structure of the signal receiving node, or a non-ideal factor caused by a hardware difference, a signal processing difference, or the like between the signal transmitting node and the signal receiving node. The non-ideal factor may be caused by a hardware defect of a node participating in sensing, or may be caused by active adjustment and control performed by the signal transmitting node and/or the signal receiving node. This is not specifically limited herein.

The non-ideal factor may affect accuracy of the first measurement value. For example, it is assumed that signal transmit power agreed upon in advance by the signal transmitting node is 100 W. However, due to active power control by the signal transmitting node or a hardware defect of a power amplifier, actual signal transmit power of the signal transmitting node is 99 W. When receiving the first signal, the signal receiving node still considers that transmit power of the first signal is 100 W. Consequently, there is a deviation between the first measurement value (for example, reflected signal strength of a sensing target and a path loss between the sensing nodes) determined based on receive power of the first signal and the transmit power 100 W of the first signal and the true value.

It should be noted that a manner of obtaining the first information by the first node may include at least one of the following:
the first node obtains at least a part of pre-stored first information; or
the first node receives at least a part of first information from another sensing node (for example, the signal receiving node or the signal transmitting node) or the first device.

In an implementation, the first information includes at least one of the following:
(1) Parameter information of at least one reference path in a channel between the signal transmitting node and the signal receiving node of the first service: In some embodiments, the parameter information of the reference path may include at least one of the following: an amplitude, a phase, a delay, an azimuth angle of departure relative to the signal transmitting node of the first service, an elevation angle of departure relative to the signal transmitting node of the first service, an azimuth angle of arrival relative to the signal receiving node of the first service, or an elevation angle of arrival relative to the signal receiving node of the first service. The reference path may be a Line of Sight (LOS) propagation path or any specified reflection path, and the reference path represents a reference path for calibrating the first measurement value subsequently obtained through sensing measurement. For example, if the reference path is a LOS path, and it is learned, based on a line of sight distance between the signal transmitting node and the signal receiving node, that a delay of the LOS path is 100 ns, the first node may calibrate the subsequent first measurement value based on the LOS path whose delay is 100 ns. If a delay of the LOS path actually obtained based on the first measurement value is 102 ns, after calibration processing is performed, a delay of the LOS path obtained based on the second measurement value should be 100 ns. Only delay information of the reference path is used as an example above. There is a similar case for the amplitude, the phase, the azimuth angle of departure, the elevation angle of departure, the azimuth angle of arrival, and the elevation angle of arrival of the reference path. Details are not described herein again.
(2) Doppler frequency of at least one reference path in the channel between the signal transmitting node and the signal receiving node of the first service: In a case in which there is more than one first measurement value, if the first measurement value is related to a Doppler frequency, a Doppler frequency for obtaining the first measurement value may be calibrated based on the Doppler frequency of the at least one reference path. For example, if the reference path is a LOS path, and a Doppler frequency of the LOS path is 0 Hz because a relative location between the signal transmitting node and the signal receiving node is unchanged, the first node may calibrate the subsequent first measurement value based on the LOS path whose Doppler frequency is 0 Hz. If a Doppler frequency of the

LOS path actually obtained based on the more than one first measurement value is 5 Hz, after calibration processing is performed, a Doppler frequency of the LOS path obtained based on more than one second measurement value should be 0 Hz.
(3) First indication information: The first indication information is used to indicate to perform division processing on a first measurement value obtained through measurement by a first antenna and a first measurement value obtained through measurement by a second antenna, to obtain a first value, the signal receiving node of the first service includes the first antenna and the second antenna, and the second measurement value includes the first value. In a case in which the signal receiving node can obtain the first measurement value from at least two receive antennas, the first indication information is used to indicate to perform division processing on first measurement values obtained by two specific receive antennas. Interference of some non-ideal factors can be eliminated by performing division processing on the first measurement values obtained by the two receive antennas. For example, when non-ideal factors of the two receive antennas are the same, impact of the non-ideal factors may be eliminated for an obtained result by performing division processing on the first measurement values of the two receive antennas.
(4) First identification information: In a case in which there is more than one first measurement value, the first identification information indicates a first measurement value used to obtain the parameter information of the at least one reference path. The first identification information may be used to indicate a first measurement value or a group of first measurement values to be used as a reference for calibration.
(5) Second information: The second information includes information related to a time offset between at least two signal receiving nodes of the first service. In a case in which there are at least two signal receiving nodes, time asynchronization between the at least two signal receiving nodes may be eliminated or reduced by using the second information. In some embodiments, the second information includes at least one of the following: measurement time offset information, measurement period information, or measurement timestamp information. For example, in a process of tracking a trajectory of the sensing target by using a plurality of signal receiving nodes, the plurality of signal receiving nodes need to simultaneously perform measurement. However, due to impact of a non-ideal factor, measurement moments of different signal receiving nodes may be different. In this case, the signal transmitting node or the first device may indicate a reference time, to provide a reference for calibration of all the signal receiving nodes.
(6) Transmit power control information of the signal transmitting node of the first service: The transmit power control information may include at least one of the following: a transmit power adjustment value in an analog domain, a transmit power adjustment value in a digital domain, or a control factor used to control transmit power of the first signal related to the first service. The transmit power adjustment value in the analog domain and the transmit power adjustment value in the digital domain may be adjustment values relative to transmit power at which the first signal is sent last time, or may be adjustment values relative to transmit power at which the first signal is sent at any specified time. The transmit power control factor may be a control factor used to control the transmit power of the first signal. The transmit power of the first signal can be calibrated based on the transmit power control information.
(7) In-phase I signal compensation information of the signal transmitting node of the first service: The I signal compensation information may be an I data amplitude compensation value or compensation factor, and the I signal compensation information is used to calibrate a phase of an I signal to achieve IQ balance.
(8) Quadrature Q signal compensation information of the signal transmitting node of the first service: The Q signal compensation information may be a Q data amplitude compensation value or compensation factor, and the Q signal compensation information is used to calibrate a phase of a Q signal to achieve IQ balance.
(9) Antenna amplitude calibration information of the signal transmitting node of the first service: The antenna amplitude calibration information is used to calibrate an amplitude of at least one transmit antenna of the signal transmitting node. For example, the antenna amplitude calibration information includes an amplitude calibration value of the at least one transmit antenna of the signal transmitting node.
(10) Phase offset calibration information of the signal transmitting node of the first service: The phase offset calibration information is used to calibrate a phase offset of at least one transmit antenna of the signal transmitting node. For example, the phase offset calibration information includes a phase calibration value of the at least one transmit antenna of the signal transmitting node.
(11) Receive power control information of the signal receiving node of the first service: The receive power control information of the signal receiving node is similar to the transmit power control information of the signal transmitting node. For example, the receive power control information includes at least one of the following: a receive power adjustment value in the analog domain, a receive power adjustment value in the digital domain, or a control factor used to control receive power of the first signal related to the first service. The receive power of the first signal can be calibrated based on the receive power control information.
(12) I signal compensation information of the signal receiving node of the first service: The I signal compensation information of the signal receiving node is similar to the I signal compensation information of the signal transmitting node, and has a same function. Details are not described herein again.
(13) Q signal compensation information of the signal receiving node of the first service: The Q signal compensation information of the signal receiving node is similar to the Q signal compensation information of the signal transmitting node, and has a same function. Details are not described herein again.
(14) Antenna amplitude calibration information of the signal receiving node of the first service: The antenna amplitude calibration information of the signal receiving node is similar to the antenna amplitude calibration information of the signal transmitting node, and the antenna amplitude calibration information of the signal receiving node may be used to calibrate an antenna amplitude of at least one receive antenna of the signal receiving node. Details are not described herein again.
(15) Phase offset calibration information of the signal receiving node of the first service: The phase offset calibration information of the signal receiving node is similar to the phase offset calibration information of the signal transmitting node, and the phase offset calibration information of the signal receiving node may be used to calibrate a phase of at least one receive antenna of the signal receiving node. Details are not described herein again.
(16) Timestamp information of obtaining the first measurement value by the signal receiving node of the first service: The timestamp information may reflect a time of obtaining each first measurement value. The timestamp information may include a time difference relative to a specified reference time, and the reference time may be specified by at least one of the signal transmitting node, the signal receiving node, or the first device. In some embodiments, the timestamp information may include an association relationship between a timestamp sequence number and a first measurement value sequence number. In this way, a timestamp corresponding to each first measurement value can be determined based on the association relationship. The timestamp information may be used to calibrate a time offset between first measurement values.
(17) Time offset calibration information between the signal transmitting node and the signal receiving node of the first service: The time offset calibration information may be used to perform time calibration on the signal transmitting node and the signal receiving node.
(18) Frequency offset calibration information between the signal transmitting node and the signal receiving node of the first service: The frequency offset calibration information may be used to perform frequency calibration on the signal transmitting node and the signal receiving node.

It should be noted that in implementation, the at least one reference path may be selected by at least one of the signal transmitting node, the signal receiving node, or the first device. Details are not described herein again.

In addition, the reference path is usually a LOS path. If the reference path is a Non Line of Sight (NLOS) propagation path, the reference path may be a reference path with relatively high power or a relatively high Signal-to-Noise Ratio (SNR), or an NLOS reference path with known parameter information. The parameter information of the reference path may be obtained based on sensing prior information.

In some embodiments, the parameter information of the reference path may be a measurement value that has an error and that includes impact of a non-ideal factor. Details are not specifically described herein again.

In some embodiments, the time offset calibration information may include at least one of the following:
a time calibration value between the signal transmitting node and the signal receiving node of the first service;
channel state information CSI or a channel impulse response phase calibration value indicated by the signal transmitting node of the first service to the signal receiving node of the first service; or
the CSI or a channel impulse response calibration coefficient indicated by the signal transmitting node of the first service to the signal receiving node of the first service.

In this implementation, time calibration may be performed between the signal transmitting node and the signal receiving node based on the time offset calibration information. In this way, a deviation that is between a sampling time point and an expected time point and that is caused by a non-ideal hardware factor such as a clock existing when the signal receiving node samples the first signal can be reduced.

In an application, the deviation between the sampling time point and the expected time point causes a frequency estimation error and generation of an alias frequency for a parameter estimation algorithm (for example, standard Fast Fourier Transform (FFT)) based on data sampled at an equal time interval. For a sensing/integrated sensing and communication service that requires a plurality of nodes to synchronously perform sensing, for example, joint trajectory tracking of a passive moving object by a plurality of sensing nodes, the deviation between the sampling time point and the expected time point is prone to cause a case in which the sensing nodes cannot simultaneously perform sampling, and finally a relatively large error is generated in a sensing result.

In some embodiments, the frequency offset calibration information between the signal transmitting node and the signal receiving node of the first service includes at least one of the following:
a frequency calibration value between the signal transmitting node and the signal receiving node of the first service;
CSI or a channel impulse response phase calibration value indicated by the signal transmitting node of the first service to the signal receiving node of the first service; or
the CSI or a channel impulse response calibration coefficient indicated by the signal transmitting node of the first service to the signal receiving node of the first service.

In a possible implementation, a frequency offset in a sensing/integrated sensing and communication system mainly means that because there is an inevitable drift of a clock crystal oscillator between a transmitter and a receiver, precise synchronization cannot be implemented between the transmitter and the receiver over time.

It is assumed that a transmitted baseband signal is s₀(t), a carrier frequency is f_{c}, and a transmitted signal is s(t)=s₀(t)e^{j2πf}^{_{c}}. In addition, it is assumed that a radio channel between the transmitter and the receiver is H(f, t)=πₗ₌₁^{L}aₗ(t)e^{-j2πfτ}^{ₗ}e^{j2πf}^{_{d,l}}^{t}, where L is a total quantity of multipaths in the channel, τₗ is a delay of an l^{th} multipath, and f_{d,l} is a Doppler frequency of the l^{th} multipath. Ideally, after the transmitted signal passes through the channel, a signal received by an antenna of the receiver is r(t)=s₀(t)e^{j2πf}^{_{c}}·Σₗ₌₁^{L}aₗ(t)e^{-j2πf}^{_{c}}^{τ}^{ₗ}e^{j2πf}^{_{d,l}}^{t}.

For a signal receiving node in the sensing system, if the signal s₀(t) and the carrier frequency f_{c} are known, H(f, t) may be obtained based on the received signal r(t), that is, a CSI matrix including sensing information is obtained. Further, a sensing measurement quantity, for example, τₗ and f_{d,l}, may be obtained by using a parameter estimation algorithm such as FFT or MUSIC.

For a signal receiving node in a communication system, the transmitted baseband signal s₀(t) may be obtained by down-converting the received signal based on the known carrier frequency f_{c} and completing channel estimation to obtain CSI.

However, due to the drift of the clock crystal oscillator, an actual signal carrier frequency of the transmitter is f′_{c}=f_{c}+Δf₁(t), and an actual down-conversion frequency on a receiver side is f″_{c}=f_{c}+Δf₂(t). For the receiver in the sensing system, the signal received by the antenna may be expressed as the following formula (1):

$$\begin{matrix}r ( t ) = {s}_{0} ( t ) e \text{?} \cdot {\sum }_{l = 1}^{L} {a}_{l} ( t ) e \text{?} e \text{?} , \\ = {s}_{0} ( t ) e \text{?} \cdot {\sum }_{l = 1}^{L} {a}_{l} ( t ) e \text{?} e \text{?} ,\end{matrix} \qquad ( 1 )$$

$$\text{?} \text{indicates text missing or illegible when filed}$$

Herein, τ′ₗ(t)=τₗ+Δt(t)=τₗ+Δf₁(t)τₗ. After down-conversion, obtained channel estimation with a frequency offset may be expressed as the following formula (2):

$$\begin{matrix}{H}^{′} ( f , t ) = e \text{?} \cdot {\sum }_{l = 1}^{L} {a}_{l} ( t ) e \text{?} e \text{?} , \\ = {\sum }_{l = 1}^{L} {a}_{l} ( t ) e \text{?} e \text{?} , \\ = {\sum }_{l = 1}^{L} {a}_{l} ( t ) e \text{?} e \text{?} ,\end{matrix} \qquad ( 2 )$$

$$\text{?} \text{indicates text missing or illegible when filed}$$

Herein,

$${f}_{d , l}^{′} ( t ) = {f}_{d , l} + \frac{[ Δ {f}_{1} ( t ) - Δ {f}_{2} ( t ) ]}{t} = {f}_{d , l} ++ Δ {f}_{3} ( t ) .$$

It may be learned from the foregoing that due to a frequency offset between the transmitter and the receiver, a first measurement value obtained when the sensing measurement quantity is estimated is not a true value, and there is an error between the first measurement value and the true value. In addition, clock frequency offsets Δf₁(t) and Δf₂(t) usually vary with time. Therefore, even if true values τₗ and f_{d,l} of sensing measurement quantities remain unchanged, first measurement values τ′ₗ and f′_{d,l} of the sensing measurement quantities vary with time. This makes calibration difficult.

It should be noted that the formula (2) may be further expressed as the following formula (3):

$$\begin{matrix}{H}^{′} ( f , t ) = e \text{?} \cdot {\sum }_{l = 1}^{L} {a}_{l} ( t ) e \text{?} e \text{?} , \\ = {\sum }_{l = 1}^{L} {a}_{l} ( t ) e \text{?} e \text{?} , \\ = {\sum }_{l = 1}^{L} {a}_{l} ( t ) e \text{?} e \text{?} ,\end{matrix} \qquad ( 3 )$$

$$\text{?} \text{indicates text missing or illegible when filed}$$

It may be learned that an error introduced by the frequency offset simultaneously acts on different sensing measurement quantities, and for any sensing measurement quantity, a specific value of the error depends on estimation accuracy of another sensing measurement quantity. If the sensing measurement quantity further includes a multipath complex amplitude aₗ, the foregoing conclusion also holds true. Details are not described herein again.

It should be noted that the error introduced by the frequency offset acts on all multipaths of the CSI, and a same error value is introduced for all the multipaths (see the formula (2) and the formula (3)).

In a calibration method, a process is as follows:

It is assumed that the first node knows that a true delay value of any l^{th} multipath (which is usually a LOS path or may be any NLOS path in some cases, for example, a known NLOS reflection path of a sensing reference node, where the reference node may be a reconfigurable intelligent surface (RIS) or the like) is τₗ, and a delay that is of the l^{th} multipath and that is obtained through measurement is τ′ₗ. In this case, the first node may first perform delay calibration on all multipaths of the CSI matrix, that is, perform delay calibration on all the multipaths of the CSI matrix by using the following formula (4):

$$\begin{matrix}{H}_{1} ( f , t ) = e \text{?} \cdot {\sum }_{l = 1}^{L} {a}_{l} ( t ) e \text{?} e \text{?} \\ = {\sum }_{l = 1}^{L} {a}_{l} ( t ) e \text{?} e \text{?}\end{matrix} \qquad ( 4 )$$

$$\text{?} \text{indicates text missing or illegible when filed}$$

In addition, it is assumed that the first node knows that a true Doppler frequency value of any l^{th} multipath (which is usually also a LOS path or may be any NLOS path in some cases) in a time period T is f_{d,l}, and Doppler calibration is performed based on a CSI matrix obtained after delay calibration. First, a complex amplitude (including Doppler) of a multipath with a known delay of τₗ needs to be extracted based on the CSI matrix, and the following formula (5) is estimated by using maximum likelihood:

$$\begin{matrix}{H}_{{r}_{1}} ( f , t ) = e \text{?} \cdot {H}_{1} ( f , t ) \\ = e \text{?} \cdot {\sum }_{l = 1}^{L} {a}_{i} ( t ) e \text{?} e \text{?} \\ = {a}_{i} ( t ) e \text{?} e \text{?} {\sum }_{k = 1 , k = i}^{L} {a}_{k} ( t ) e \text{?} e \text{?} \\ \approx {a}_{i} ( t ) e \text{?}\end{matrix} . \qquad ( 5 )$$

$$\text{?} \text{indicates text missing or illegible when filed}$$

By calibrating the Doppler of the path, CSI, obtained after calibration, at a moment tₛ (tₛ is a time difference relative to a reference moment) in the time period T may be obtained, that is, the CSI, obtained after calibration, at the moment tₛ in the time period T is determined by using the following formula (6):

$$\begin{matrix}{H}_{c} ( f , {t}_{s} ) = e \text{?} \cdot {H}_{1} ( f , t ) \\ = e \text{?} \cdot e \text{?} \cdot {\sum }_{l = 1}^{L} {a}_{i} ( {t}_{s} ) e \text{?} e \text{?} \\ = {\sum }_{k = 1 , k = i}^{L} {a}_{i} ( {t}_{s} ) e \text{?} e \text{?}\end{matrix} . \qquad ( 6 )$$

$$\text{?} \text{indicates text missing or illegible when filed}$$

In this case, errors in both the sensing measurement quantities τₗ and f_{d,l} of the l^{th} multipath are eliminated. Because the error caused by the frequency offset has same impact on all the multipaths, errors caused by the frequency offset in all other multipaths can also be eliminated. It should be noted that when the Doppler frequency is calibrated, because the frequency offset error varies with time, all CSI samples need to be calibrated one by one based on the formula (6).

In addition, a true complex amplitude aₗ of the l^{th} multipath in the time period T usually cannot be determined. Therefore, during calibration, there needs to be a unified reference moment (a sampling moment of a first sample in the time period T usually may be selected) for samples at different moments tₛ, to determine a value of tₛ and a phase calibration value of each CSI sample. In other words, the foregoing Doppler calibration is essentially calibration of a relative phase between a plurality of consecutive CSI samples.

It should be noted that if the transmitter or the receiver in the sensing system has a plurality of antennas, because the plurality of antennas usually use a same clock source, channel delay calibration and Doppler calibration may be further implemented by using a method of using a CSI ratio of two antennas, to eliminate errors introduced by the frequency offset to the plurality of antennas. This method is simple to implement and has a low operation amount, but requires a device to have a plurality of antennas. After calibration, channel information of one antenna port is lost. Details are not specifically described herein again.

In this embodiment of this application, based on the time offset calibration information between the signal transmitting node and the signal receiving node and the frequency offset calibration information between the signal transmitting node and the signal receiving node, time offset calibration and frequency offset calibration can be implemented by using a single antenna.

In an implementation, after the first node performs calibration processing on the first measurement value based on the first information, to obtain the second measurement value, the method further includes:

In a case in which the first node includes the computing node, the first node determines the sensing result of the first service based on the second measurement value; or
in a case in which the first node does not include the computing node, the first node sends the second measurement value to the computing node, where the computing node is configured to determine the sensing result of the first service based on the second measurement value.

Case 1: In the case in which the first node includes the computing node, the first node and the computing node may be a same node or device.

In a possible implementation, an example in which the sensing node A sends the first signal, the sensing node B receives the first signal, and the first node and the computing node are the first device is used. The first device may obtain the first measurement value from the sensing node B, obtain the first information from the sensing node A and/or the sensing node B, calibrate the first measurement value based on the first information, to obtain the second measurement value, and then compute the sensing result of the first service based on the second measurement value.

In a possible implementation, an example in which the sensing node A sends the first signal and receives the echo signal of the first signal, and the first node and the computing node are the first device is used. The first device may obtain the first measurement value and the first information from the sensing node A, calibrate the first measurement value based on the first information, to obtain the second measurement value, and then compute the sensing result of the first service based on the second measurement value.

In this implementation, the computing node may be reused to calibrate the first measurement value.

Case 2: In the case in which the first node does not include the computing node, the first node and the computing node may be different nodes or devices.

In a possible implementation, an example in which the sensing node A sends the first signal, the sensing node B receives the first signal, the first node is the sensing node B, and the computing node is the sensing node A or the first device is used. The sensing node B may perform sensing measurement on the first signal to obtain the first measurement value, obtain the first information from the sensing node A and/or the first device, and calibrate the first measurement value based on the first information, to obtain the second measurement value, and then the sensing node B may further send the second measurement value to the computing node (the sensing node A or the first device).

In an implementation, an example in which the sensing node A sends the first signal, the sensing node B receives the first signal, the first node is the sensing node A, and the computing node is the first device is used. The sensing node A may obtain the first measurement value from the sensing node B, obtain the first information from the sensing node B and/or the first device, and calibrate the first measurement value based on the first information, to obtain the second measurement value, and then the sensing node A may further send the second measurement value to the first device.

In an implementation, an example in which the sensing node A sends the first signal and receives the echo signal of the first signal, the first node is the sensing node A, and the computing node is the first device is used. The sensing node A may perform sensing measurement on the echo signal of the first signal to obtain the first measurement value, obtain the first information from the first device, and calibrate the first measurement value based on the first information, to obtain the second measurement value, and then the sensing node A may further send the second measurement value to the first device.

In this implementation, after calibrating the first measurement value, the first node may further send the second measurement value obtained after calibration to the computing node, so that the computing node obtains a more accurate sensing result based on the second measurement value.

In an implementation, that the first node obtains first information includes:

The first node receives the first information from a second node, where the second node includes at least one node that is in the signal transmitting node of the first service, the signal receiving node of the first service, and the computing node and that is different from the first node.

In this implementation, the first node receives the first information from at least one of the signal transmitting node, the signal receiving node, or the computing node of the first service, so that the first node learns of non-ideal factors of the signal transmitting node, the signal receiving node, and the computing node, and accordingly calibrates the first measurement value, to improve calibration accuracy.

It should be noted that in some embodiments, the non-ideal factor of the signal transmitting node and/or the signal receiving node of the first service may vary with time. In this case, the second node may send updated first information to the first node based on updated sensing prior information and/or an updated first measurement value from the signal transmitting node and/or the signal receiving node. In this way, the first node can learn of a current non-ideal factor of the signal transmitting node and/or the signal receiving node based on the updated first information.

In some embodiments, before the first node receives the first information from the second node, the method further includes:

The first node sends third information to the second node, where
the third information includes at least one of the following: the first measurement value, a historical measurement value of a sensing measurement quantity corresponding to the first measurement value, or fourth information, the third information is used to assist the second node in determining the first information, and the fourth information is related to at least one of the following of the signal transmitting node and/or the signal receiving node of the first service: physical state information, hardware information, sensing capability information, or communication capability information.

The third information is used to provide a basis for determining the first information by the second node. The fourth information may be prior information, and the first node may obtain the prior information before obtaining the first information. For example, if the third information includes the first measurement value and the hardware information of the signal transmitting node and the signal receiving node, the second node may determine, based on the third information, how to calibrate the first measurement value, to feed back the first information used to calibrate the first measurement value to the first node.

In some embodiments, the physical state information includes at least one of the following:
(1) Target state information of the signal receiving node of the first service: The target state information includes at least one of movement speed information, location information, or antenna array orientation information of the signal receiving node. The movement speed information may include a movement speed and a movement direction. The location information may be location coordinates relative to a predetermined reference location. In a multi-antenna scenario, the target state information may further include the antenna array orientation information of the signal receiving node. In implementation, when the first node is the signal receiving node, the first node may send the target state information of the signal receiving node to the second node.
(2) Target state information of the signal transmitting node of the first service: The target state information of the signal transmitting node is similar to the target state information of the signal receiving node. In implementation, when the first node is the signal transmitting node, the first node may send the target state information of the signal transmitting node to the second node.
(3) Distance information of a target antenna pair: The target antenna pair includes a transmit antenna of the signal transmitting node of the first service and a receive antenna of the signal receiving node of the first service. In implementation, a measurement quantity of the first signal may be related to the distance information of the target antenna pair. For example, a transmission delay of the first signal is positively related to an absolute distance of the target antenna pair. In this way, the first measurement value of the measurement quantity is calibrated based on the distance information of the target antenna pair, so that the second measurement value obtained after calibration can match the distance information of the target antenna pair.

In implementation, the target state information can affect the measurement quantity of the first signal. Therefore, how to calibrate the first measurement value of the measurement quantity can be determined based on the target state information, so that the second measurement value obtained after calibration can match the target state information of the signal transmitting node and/or the signal receiving node.

In some embodiments, the hardware information includes at least one of the following: a quantity of physical antennas, maximum transmit power, a power amplifier gain, power amplifier bandwidth, power amplifier efficiency, power amplifier linearity, maximum output power of a power amplifier, a minimum adjustment step for power control in an analog domain, a minimum adjustment step for power control in a digital domain, a dynamic range of an Analog-to-Digital Converter (ADC), a dynamic range of a Digital-to-Analog Converter (DAC), or sensing sensitivity.

The hardware information may include the hardware information of the signal transmitting node and/or the signal receiving node, and can affect the transmit power, the receive power, accuracy of the transmit power, accuracy of the receive power, and the like of the first signal. In this way, after the hardware information is sent to the second node, the second node may determine a deviation between a sent signal of the signal transmitting node and the expected first signal and/or a deviation between a received signal of the signal receiving node and the expected first signal based on the hardware information, and then accordingly determine how to calibrate the first measurement value, that is, determine the first information used to calibrate the first measurement value. Details are not described herein again.

In some embodiments, the sensing capability information and/or the communication capability information in the fourth information may include at least one of the following:
the sensing capability information of the signal transmitting node of the first service;
the communication capability information of the signal transmitting node of the first service;
the sensing capability information of the signal receiving node of the first service; or
the communication capability information of the signal receiving node of the first service.

The sensing capability information may include at least one of the following: maximum bandwidth available for sensing, a time domain resource available for sensing, a frequency domain resource available for sensing, an antenna port resource available for sensing, or a quantity of physical antennas available for sensing, where the antenna port resource available for sensing includes a quantity of antenna ports available for sensing and a mapping relationship between an antenna port and a physical antenna.

The time domain resource and the frequency domain resource may include a time-frequency resource location, a frequency domain resource density, a frequency domain quantity, a time domain resource length/quantity, a density/period, and the like. The sensing sensitivity may be minimum strength that can be used to receive the first signal and that is required for the signal receiving node of the first service to maintain normal sensing, and may be expressed in terms of power or strength.

The sensing capability information may reflect a sensing capability of the sensing node, and helps the second node accordingly determine how to calibrate the first measurement value. For example, in a case in which the sensing capability information includes the time domain resource available for sensing, the second node may accordingly determine a time domain deviation of the first measurement value.

In addition, the communication capability information may include at least one of the following: maximum bandwidth available for communication, a time domain resource available for communication, a frequency domain resource available for communication, an antenna port resource available for communication, or a quantity of physical antennas available for communication, where the antenna port resource available for communication includes a quantity of antenna ports available for communication and a mapping relationship between an antenna port and a physical antenna.

The communication capability information may reflect a communication capability of the sensing node, and based on the communication capability, the second node may be assisted in determining interference of a non-ideal factor in terms of the communication capability to the first measurement value.

It should be noted that in implementation, at least one of the time domain resource, the frequency domain resource, the antenna port resource, and the physical antenna available for sensing may partially or completely overlap at least one of the time domain resource, the frequency domain resource, the antenna port resource, or the physical antenna available for communication. This is not specifically limited herein.

It should be noted that in some implementations, the first node and the second node may be a same node. For example, when obtaining third information from another sensing node, the first node may determine the first information based on the third information. This is not specifically limited herein.

In an implementation, that the first node obtains a first measurement value includes:

In a case in which the first node includes the signal receiving node of the first service, the first node measures the first signal related to the first service, to obtain the first measurement value.

In this way, the signal receiving node of the first service may be reused as the first node to calibrate the first measurement value. In this way, the signal receiving node of the first service does not need to transfer the first measurement value to the first node.

In another implementation, in a case in which the first node does not include the signal receiving node of the first service, the first node receives the first measurement value from the signal receiving node of the first service.

In this way, in a case in which the first node and the signal receiving node of the first service are different nodes, for example, the signal receiving node of the first service does not have a capability of calibrating the first measurement value, the first node receives the first measurement value from the signal receiving node of the first service, and calibrates the first measurement value based on the first information. In this way, a process of calibrating the first measurement value can be made more flexible.

In this embodiment of this application, the first node obtains the first information, and obtains the first measurement value, where the first information is used to indicate the non-ideal factor existing when the at least one sensing node executes the first service, the first service includes the sensing service or the integrated sensing and communication service, and the non-ideal factor includes the factor causing at least one of the frequency deviation, the time deviation, the power deviation, the amplitude deviation, or the phase deviation between the first measurement value and the true value; and the first node performs calibration processing on the first measurement value based on the first information, to obtain the second measurement value, where the sensing result of the first service is determined based on the second measurement value. In this way, the first node can calibrate, based on a non-ideal factor of the sensing node of the first service, the first measurement value obtained through sensing measurement, to reduce a deviation between the second measurement value obtained after calibration and the true value, so as to improve accuracy of the sensing result obtained based on the second measurement value, and improve sensing performance.

With reference to FIG. 4, an embodiment of this application provides an information transmission method. An execution body of the information transmission method may include a second node. The second node may include at least one of a terminal, a base station, a core network device, or another communication device. As shown in FIG. 4, the information transmission method may include the following step.

Step 401: The second node sends first information to a first node, where the first information is used to indicate a non-ideal factor existing when at least one sensing node executes a first service, the first information is used to calibrate a first measurement value of the first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value.

The second node may be a node that provides the first information to the first node in the method embodiment shown in FIG. 2, and the second node may be at least one of a signal transmitting node, a signal receiving node, or a computing node of the first service. Details are not described herein again.

It should be noted that meanings and functions of the first information, the non-ideal factor, calibration of the first measurement value, and the like in this embodiment of this application are the same as meanings and functions of the first information, the non-ideal factor, calibration of the first measurement value, and the like in the method embodiment shown in FIG. 2. Details are not described herein again.

In some embodiments, the second node includes at least one of the following:
a signal transmitting node, where the signal transmitting node is configured to send a first signal related to the first service;
a signal receiving node, where the signal receiving node is configured to measure the first signal to obtain the first measurement value; or
a computing node, where the computing node is configured to determine a sensing result of the first service based on a second measurement value, and the second measurement value is a measurement value obtained after the first measurement value is calibrated based on the first information; and
the second node is different from the first node.

In some embodiments, the first information includes at least one of the following:
parameter information of at least one reference path in a channel between a signal transmitting node and a signal receiving node of the first service;
a Doppler frequency of at least one reference path in the channel between the signal transmitting node and the signal receiving node of the first service;
first indication information, where the first indication information is used to indicate to perform division processing on a first measurement value obtained through measurement by a first antenna and a first measurement value obtained through measurement by a second antenna, to obtain a first value, the signal receiving node of the first service includes the first antenna and the second antenna, and the second measurement value includes the first value;
first identification information, where in a case in which there is more than one first measurement value, the first identification information indicates a first measurement value used to obtain the parameter information of the at least one reference path;
second information, where the second information includes information related to a time offset between at least two signal receiving nodes of the first service;
transmit power control information of the signal transmitting node of the first service;
in-phase I signal compensation information of the signal transmitting node of the first service;
quadrature Q signal compensation information of the signal transmitting node of the first service;
antenna amplitude calibration information of the signal transmitting node of the first service;
phase offset calibration information of the signal transmitting node of the first service;
receive power control information of the signal receiving node of the first service;
I signal compensation information of the signal receiving node of the first service;
Q signal compensation information of the signal receiving node of the first service;
antenna amplitude calibration information of the signal receiving node of the first service;
phase offset calibration information of the signal receiving node of the first service;
timestamp information of obtaining the first measurement value by the signal receiving node of the first service;
time offset calibration information between the signal transmitting node and the signal receiving node of the first service; or
frequency offset calibration information between the signal transmitting node and the signal receiving node of the first service.

In some embodiments, before the second node sends the first information to the first node, the method further includes:

The second node obtains third information, where the third information includes at least one of the following: the first measurement value, a historical measurement value of a sensing measurement quantity corresponding to the first measurement value, or fourth information, and the fourth information is related to at least one of the following of the signal transmitting node and/or the signal receiving node of the first service: physical state information, hardware information, sensing capability information, or communication capability information; and
the second node determines the first information based on the third information.

In implementation, the second node may receive the third information from the first node, or may receive third information from another node that executes the first service. For example, in a case in which a sensing node A sends the first signal, a sensing node B receives the first signal, the first node is the sensing node B, and the computing node is the sensing node A or a first device, if the second node is the first device, the first device may receive the third information from the sensing node A and/or the sensing node B.

In some embodiments, the sensing measurement quantity corresponding to the first measurement value includes at least one of the following:
a frequency domain channel response between the signal transmitting node and the signal receiving node of the first service; or
a channel impulse response between the signal transmitting node and the signal receiving node of the first service.

In some embodiments, the physical state information includes at least one of the following:
target state information of the signal receiving node of the first service, where the target state information includes at least one of movement speed information, location information, or antenna array orientation information of the signal receiving node;
target state information of the signal transmitting node of the first service; or
distance information of a target antenna pair, where the target antenna pair includes a transmit antenna of the signal transmitting node of the first service and a receive antenna of the signal receiving node of the first service.

In some embodiments, the fourth information includes at least one of the following:
the sensing capability information of the signal transmitting node of the first service;
the sensing capability information of the signal receiving node of the first service;
the communication capability information of the signal transmitting node of the first service; or
the communication capability information of the signal receiving node of the first service.

In some embodiments, the sensing capability information includes at least one of the following:
maximum bandwidth available for sensing, a time domain resource available for sensing, a frequency domain resource available for sensing, an antenna port resource available for sensing, and a quantity of physical antennas available for sensing, where the antenna port resource available for sensing includes a quantity of antenna ports available for sensing and a mapping relationship between an antenna port and a physical antenna; and/or
the hardware information includes at least one of the following: a quantity of physical antennas, maximum transmit power, a power amplifier gain, power amplifier bandwidth, power amplifier efficiency, power amplifier linearity, maximum output power of a power amplifier, a minimum adjustment step for power control in an analog domain, a minimum adjustment step for power control in a digital domain, a dynamic range of an analog-to-digital converter ADC, a dynamic range of a digital-to-analog converter DAC, or sensing sensitivity; and/or
the communication capability information includes at least one of the following:
maximum bandwidth available for communication, a time domain resource available for communication, a frequency domain resource available for communication, an antenna port resource available for communication, or a quantity of physical antennas available for communication, where the antenna port resource available for communication includes a quantity of antenna ports available for communication and a mapping relationship between an antenna port and a physical antenna.

In some embodiments, after the second node sends the first information to the first node, the method further includes:

The second node receives the second measurement value from the first node, where the second measurement value is a measurement value obtained after the first measurement value is calibrated based on the first information; and
the second node determines the sensing result of the first service based on the second measurement value, or the second node sends the second measurement value to the computing node, where the computing node is configured to determine the sensing result of the first service based on the second measurement value.

In this implementation, the second node may further serve as the computing node, to determine the sensing result of the first service based on the second measurement value.

In some embodiments, in a case in which the second node includes the signal receiving node of the first service, the method further includes:

The second node measures the first signal related to the first service, to obtain the first measurement value; and
the second node sends the first measurement value to the first node.

In this implementation, the second node may further serve as the signal receiving node of the first service, to measure the first signal to obtain the first measurement value, and send the first measurement value to the first node, so that the first node calibrates the first measurement value based on the first information.

In some embodiments, the parameter information of the reference path includes at least one of the following:
an amplitude, a phase, a delay, an azimuth angle of departure relative to the signal transmitting node of the first service, an elevation angle of departure relative to the signal transmitting node of the first service, an azimuth angle of arrival relative to the signal receiving node of the first service, or an elevation angle of arrival relative to the signal receiving node of the first service.

In some embodiments, the second information includes at least one of the following:
measurement time offset information, measurement period information, or measurement timestamp information.

In some embodiments, the transmit power control information includes at least one of the following:
a transmit power adjustment value in an analog domain, a transmit power adjustment value in a digital domain, or a control factor used to control transmit power of the first signal related to the first service; and/or
the receive power control information includes at least one of the following:
a receive power adjustment value in the analog domain, a receive power adjustment value in the digital domain, or a control factor used to control receive power of the first signal related to the first service.

In some embodiments, the time offset calibration information between the signal transmitting node and the signal receiving node of the first service includes at least one of the following:
a time calibration value between the signal transmitting node and the signal receiving node of the first service;
channel state information CSI or a channel impulse response phase calibration value indicated by the signal transmitting node of the first service to the signal receiving node of the first service; or
the CSI or a channel impulse response calibration coefficient indicated by the signal transmitting node of the first service to the signal receiving node of the first service.

In some embodiments, the frequency offset calibration information between the signal transmitting node and the signal receiving node of the first service includes at least one of the following:
a frequency calibration value between the signal transmitting node and the signal receiving node of the first service;
CSI or a channel impulse response phase calibration value indicated by the signal transmitting node of the first service to the signal receiving node of the first service; or
the CSI or a channel impulse response calibration coefficient indicated by the signal transmitting node of the first service to the signal receiving node of the first service.

In this embodiment of this application, the second node provides the first information to the first node, so that the first node calibrates the first measurement value based on the first information. In this case, the second measurement value obtained after calibration can overcome interference of the non-ideal factor and a deviation from the true value is reduced. In this way, when the sensing result of the first service is determined based on the second measurement value, sensing accuracy can be improved.

To facilitate description of the calibration method and the information transmission method provided in the embodiments of this application, the following five application scenarios are used as examples for description.

### Scenario 1

As shown in FIG. 3a, a sensing node A sends a first signal, a sensing node B receives the first signal, a first node is the sensing node B, and a computing node is the sensing node A or a first device. In this case, the calibration method and the information transmission method provided in the embodiments of this application may include the following processes.

Step 1a: The sensing node A or the first device obtains sensing prior information. The sensing prior information is used to assist the sensing node A or the first device in determining first information. The first information is used to assist the sensing node B in calibrating a subsequent first measurement value.

The sensing prior information may be the fourth information in the method embodiment shown in FIG. 2. In this embodiment, the fourth information may include at least one of the following:
target state information of the sensing node B, target state information of the sensing node A, an absolute distance of a target antenna pair of the sensing node A and the sensing node B, hardware information of the sensing node B, hardware information of the sensing node A, sensing and/or communication capability information of the sensing node B, or sensing and/or communication capability information of the sensing node A.

Step 2a: The sensing node B receives the first signal, and obtains the first measurement value, and the sensing node B feeds back the first measurement value to the sensing node A or the first device.

The first measurement value is a measurement value that is of a sensing measurement quantity and that includes impact of a non-ideal factor.

It should be noted that in implementation, a sequence of step 1a and step 2a is not limited. For example, step 2a may be performed before step 1a, step 1a may be performed before step 2a, or step 1a and step 2a may be simultaneously performed. For example, the sensing node B first receives the first signal, and obtains the first measurement value, and then the sensing node B sends the first measurement value and the target state information, the hardware information, and the sensing and/or communication capability information of the sensing node B to the sensing node A or the first device.

Step 3a: The sensing node A or the first device sends the first information to the sensing node B based on the sensing prior information and the first measurement value that are sent by the sensing node B.

The first information is used to assist the sensing node B in calibrating the first measurement value. In this embodiment, the first information may include at least one of the following:
parameter information of at least one reference path in a channel between the sensing node A and the sensing node B, where the reference path is selected by the sensing node A or the first device, and is a reference path for subsequently calibrating a measurement value of a measurement quantity by the sensing node B;
a Doppler frequency of at least one reference path in the channel between the sensing node A and the sensing node B, where if the sensing node B provides at least one consecutive group of first measurement values in step 2a, the first information includes the Doppler frequency of the at least one reference path in the channel between the sensing node A and the sensing node B, and the reference path may be selected by the sensing node A;
first indication information, where if the first measurement value from the sensing node B can be obtained from a plurality of receive antennas, the first information may further include the first indication information in the foregoing embodiment;
first identification information, where if the sensing node B provides at least one consecutive group of first measurement values in step 2a, the first information may further include the first identification information in the foregoing embodiment;
second information, where if there is more than one sensing node B and at least one piece of sensing prior information (for example, location information) from at least one sensing node B is unavailable, the first information sent by the sensing node A to the sensing node B further includes the second information in the foregoing embodiment;
transmit power control information of the sensing node A;
IQ signal compensation information of the sensing node A;
time offset calibration information between the sensing node A and the sensing node B;
frequency offset calibration information between the sensing node A and the sensing node B; or
antenna amplitude and phase offset calibration information of the sensing node A.

It should be noted that in the scenario 1, a signal receiving node (the sensing node B) is reused to calibrate the first measurement value. In this case, the sensing node B may obtain a non-ideal factor existing when the sensing node B executes a first service, and no transfer needs to be performed.

Step 4a: The sensing node B calibrates the first measurement value based on the first information from the sensing node A, to obtain a second measurement value, and the sensing node B sends the second measurement value to the sensing node A or the first device.

The second measurement value is a measurement value that is of the sensing measurement quantity and for which at least some non-ideal factors are eliminated.

Step 5a: The sensing node A or the first device computes a sensing result based on at least one group of second measurement values, and sends the sensing result to a sensing requester.

It should be noted that in the scenario 1, there may be one or at least two sensing nodes A, and there may be one or at least two sensing nodes B. In this case, if there are at least two sensing nodes B, the first node may be any at least one of the at least two sensing nodes B. In this case, the first node may further obtain first information from another sensing node B, and calibrate a first measurement value from each sensing node B based on first information from the sensing node B.

### Scenario 2

As shown in FIG. 3a, a sensing node A sends a first signal, a sensing node B receives the first signal, a first node is the sensing node A, and a computing node is the sensing node A or a first device. In this case, the calibration method and the information transmission method provided in the embodiments of this application may include the following processes.

Step 1b: The sensing node A or the first device obtains sensing prior information. The sensing prior information is used to assist the node A or the first device in calibrating a subsequent first measurement value.

A specific meaning of the sensing prior information is the same as that of the sensing prior information in the scenario 1. Details are not described herein again.

Step 2b: The sensing node B receives the first signal, and obtains the first measurement value, and the sensing node B feeds back the first measurement value to the sensing node A.

Step 3b: The sensing node B sends first information to the sensing node A.

The first information is used to assist the sensing node A in calibrating the first measurement value. In this embodiment, the first information may include at least one of the following:
(1) receive power control information of the sensing node B;
(2) IQ signal compensation information of the sensing node B;
(3) time offset calibration information between the sensing node A and the sensing node B;
(4) frequency offset calibration information between the sensing node A and the sensing node B;
(5) antenna amplitude and phase offset calibration information of the sensing node B; or
(6) timestamp information of obtaining the first measurement value by the sensing node B.

A timestamp may be a time difference relative to any specified reference time. The specified reference time is jointly agreed upon by the sensing node A and the sensing node B. If the sensing node B needs to obtain at least one group of first measurement values when executing a sensing/integrated sensing and communication service, there is at least one group of timestamp information. In some embodiments, the timestamp information may further include an association relationship between a timestamp sequence number and a first measurement value sequence number.

It should be noted that in the scenario 2, a signal transmitting node (the sensing node A) is reused to calibrate the first measurement value. In this case, the sensing node A may obtain a non-ideal factor existing when the sensing node A executes a first service, and no transfer needs to be performed.

Step 4b: The sensing node A calibrates the first measurement value based on the first information from the sensing node B, to obtain a second measurement value.

In some embodiments, when the computing node is the first device, the sensing node A may send the second measurement value to the first device in this step.

Step 5b: The sensing node A or the first device computes a sensing result based on at least one group of second measurement values, and sends the sensing result to a sensing requester.

It should be noted that in this embodiment, an execution sequence of step 2b and step 3b is not limited. For example, based on different specific content of the first information, step 3b may be performed before step 2b, or may be simultaneously performed with step 2b. For example, if the first information includes only at least one of the options (1), (2), or (5), step 3b may be performed before or simultaneously performed with step 2b. If the first information further includes at least one of the options (3), (4), or (6), step 3b may be performed after or simultaneously performed with step 2b. In some embodiments, the first information may be split into a plurality of parts, and the plurality of parts may be sent a plurality of times.

In addition, in the scenario 2, there may be one or at least two sensing nodes A, and there may be one or at least two sensing nodes B. In this case, if there are at least two sensing nodes A, the first node may be any at least one of the at least two sensing nodes A. In this case, the first node may further obtain first information from another sensing node A, and calibrate, based on first information from each sensing node A, a first measurement value obtained based on a first signal sent by the sensing node A.

### Scenario 3

As shown in FIG. 3a, a sensing node A sends a first signal, a sensing node B receives the first signal, and a first node and a computing node are a first device. In this case, the calibration method and the information transmission method provided in the embodiments of this application may include the following processes.

Step 1c: The first device obtains sensing prior information. The sensing prior information is used to assist the first device in calibrating a subsequent first measurement value.

A specific meaning of the sensing prior information is the same as that of the sensing prior information in the scenario 1. Details are not described herein again.

Step 2c: The sensing node B receives the first signal, obtains the first measurement value, and sends the first measurement value to the first device.

Step 3c: The sensing node A and/or the sensing node B send/sends first information to the first device.

The first information is used to assist the first device in calibrating the first measurement value. In this embodiment, the first information may include at least one of the following:
parameter information of at least one reference path in a channel between the sensing node A and the sensing node B, where the reference path may be selected by the sensing node B, and is a reference path for subsequently calibrating a measurement value of a measurement quantity by the first device;
first indication information, where if the first measurement value from the sensing node B can be obtained from a plurality of receive antennas, the first information may further include the first indication information in the foregoing embodiment;
receive power control information of the sensing node A and/or the sensing node B;
IQ signal compensation information of the sensing node A and/or the sensing node B;
time offset calibration information between the sensing node A and the sensing node B;
frequency offset calibration information between the sensing node A and the sensing node B; or
antenna amplitude and phase offset calibration information of the sensing node A and/or the sensing node B.

Step 4c: The first device calibrates the first measurement value based on the first information from the node A and/or the node B, to obtain a second measurement value.

The second measurement value is a measurement value that is of a sensing measurement quantity and for which at least some non-ideal factors are eliminated.

Step 5c: The first device computes a sensing result based on at least one group of second measurement values, and sends the sensing result to a sensing requester.

It should be noted that in this embodiment, an execution sequence of step 2c and step 3c is not limited. For example, based on different specific content of the first information, step 3c may be performed before step 2c, or may be simultaneously performed with step 2c. For example, if the first information includes only at least one of the options (3), (4), or (7), step 3c may be performed before or simultaneously performed with step 2c. If the first information further includes at least one of the options (1), (2), (5), or (6), step 3c may be performed after or simultaneously performed with step 2c. In some embodiments, the first information may be split into a plurality of parts, and the plurality of parts may be sent a plurality of times.

In addition, in the scenario 3, there may be one or at least two sensing nodes A, and there may be one or at least two sensing nodes B. In this case, if there are at least two sensing nodes A and/or sensing nodes B, the first node may obtain first information from all the sensing nodes A and sensing nodes B, and accordingly calibrate a first measurement value. For example, if a first measurement value is obtained by a sensing node B1 by performing sensing measurement on a first signal from a sensing node A1, the first measurement value may be calibrated based on first information from the sensing node A1 and the sensing node B1.

### Scenario 4

As shown in FIG. 3b, a sensing node A sends a first signal, and receives an echo signal of the first signal, and a first node and a computing node are a first device. In this case, the calibration method and the information transmission method provided in the embodiments of this application may include the following processes.

Step 1d: The first device obtains sensing prior information.

The sensing prior information is used to assist the first device in determining first information. In this embodiment, the sensing prior information may include at least one of the following:
target state information of the sensing node A, sensing and/or communication capability information of the sensing node A, or hardware information of the sensing node A.

Step 2d: The sensing node A sends the first signal, receives the echo signal of the first signal, and obtains a first measurement value, and the sensing node A sends the first measurement value to the first device.

Step 3d: The sensing node A sends the first information to the first device.

The first information is used to assist the first device in calibrating the first measurement value. In this embodiment, the first information may include at least one of the following:
(1) transmit power control information of the sensing node A;
(2) receive power control information of the sensing node A;
(3) IQ signal compensation information of the sensing node A;
(4) antenna amplitude and phase offset calibration information of the sensing node A; or
(5) timestamp information of obtaining the first measurement value by the sensing node A.

Step 4d: The first device calibrates the first measurement value based on the first information from the sensing node A, to obtain a second measurement value.

Step 5d: The first device computes a sensing result based on at least one group of second measurement values, and sends the sensing result to a sensing requester.

It should be noted that in this embodiment, an execution sequence of step 2d and step 3d is not limited. For example, based on different specific content of the first information, step 3d may be performed before step 2d, or may be simultaneously performed with step 2d. For example, if the first information includes only at least one of the options (1), (2), or (3), step 3d may be performed before or simultaneously performed with step 2d. If the first information further includes the option (4), step 3d may be performed after or simultaneously performed with step 2d. In some embodiments, the first information may be split into a plurality of parts, and the plurality of parts may be sent a plurality of times.

In addition, in the scenario 4, there may be one or at least two sensing nodes A. If there are at least two sensing nodes A, the first node may obtain first information from all the sensing nodes A, and accordingly calibrate a first measurement value obtained through measurement based on a corresponding sensing node A.

### Scenario 5

As shown in FIG. 3b, a sensing node A sends a first signal, and receives an echo signal of the first signal, a first node is the sensing node A, and a computing node is a first device. There may be more than one sensing node A. In this case, the calibration method and the information transmission method provided in the embodiments of this application may include the following processes.

Step 1e: The first device obtains sensing prior information. The sensing prior information is used to assist the first device in determining first information.

A specific meaning of the sensing prior information is the same as that of the sensing prior information in the scenario 1. Details are not described herein again.

Step 2e: The sensing node A sends the first signal, receives the echo signal of the first signal, and obtains a first measurement value and timestamp information of the first measurement value, and the sensing node A sends the first measurement value and the timestamp information of the first measurement value to the first device.

Step 3e: The first device sends the first information to at least one sensing node A.

The first information is used to assist the sensing node A in calibrating a subsequent first measurement value. In this embodiment, the first information may include at least one of the following:
parameter information of a reference path specified by the first device, measurement time offset information, measurement period information, or measurement timestamp information.

Step 4e: The sensing node A calibrates the first measurement value based on the first information from the first device, to obtain a second measurement value, and the sensing node A sends the second measurement value to the first device.

Step 5e: The first device computes a sensing result based on at least one group of second measurement values, and sends the sensing result to a sensing requester.

In the scenario 5, there may be at least two sensing nodes A. When obtaining a first measurement value, each sensing node A further obtains timestamp information of the first measurement value. Time synchronization calibration may be performed on first measurement values from at least two sensing nodes A based on the timestamp information.

The calibration method provided in the embodiments of this application may be performed by a calibration apparatus. In the embodiments of this application, the calibration apparatus provided in the embodiments of this application is described by using an example in which the calibration apparatus performs the calibration method.

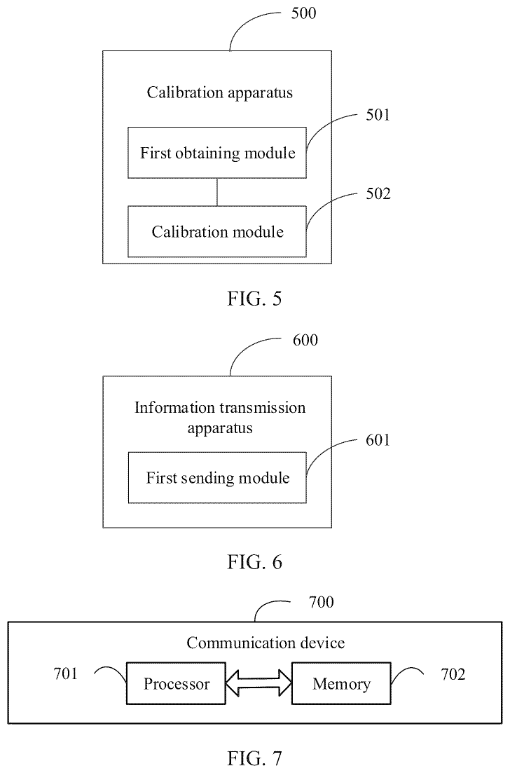

With reference to FIG. 5, an embodiment of this application further provides a calibration apparatus, applied to a first node. As shown in FIG. 5, the calibration apparatus 500 includes:
a first obtaining module 501, configured to: obtain first information, and obtain a first measurement value, where the first information is used to indicate a non-ideal factor existing when at least one sensing node executes a first service, the first service includes a sensing service or an integrated sensing and communication service, and the non-ideal factor includes a factor causing at least one of a frequency deviation, a time deviation, a power deviation, an amplitude deviation, or a phase deviation between the first measurement value and a true value; and
a calibration module 502, configured to perform calibration processing on the first measurement value based on the first information, to obtain a second measurement value, where a sensing result of the first service is determined based on the second measurement value.

In some embodiments, the first node includes at least one of the following:
a signal transmitting node, where the signal transmitting node is configured to send a first signal related to the first service;
a signal receiving node, where the signal receiving node is configured to measure the first signal to obtain the first measurement value; or
a computing node, where the computing node is configured to determine the sensing result of the first service based on the second measurement value.

In some embodiments, the first information includes at least one of the following:
parameter information of at least one reference path in a channel between a signal transmitting node and a signal receiving node of the first service;
a Doppler frequency of at least one reference path in the channel between the signal transmitting node and the signal receiving node of the first service;
first indication information, where the first indication information is used to indicate to perform division processing on a first measurement value obtained through measurement by a first antenna and a first measurement value obtained through measurement by a second antenna, to obtain a first value, the signal receiving node of the first service includes the first antenna and the second antenna, and the second measurement value includes the first value;
first identification information, where in a case in which there is more than one first measurement value, the first identification information indicates a first measurement value used to obtain the parameter information of the at least one reference path;
second information, where the second information includes information related to a time offset between at least two signal receiving nodes of the first service;
transmit power control information of the signal transmitting node of the first service;
in-phase I signal compensation information of the signal transmitting node of the first service;
quadrature Q signal compensation information of the signal transmitting node of the first service;
antenna amplitude calibration information of the signal transmitting node of the first service;
phase offset calibration information of the signal transmitting node of the first service;
receive power control information of the signal receiving node of the first service;
I signal compensation information of the signal receiving node of the first service;
Q signal compensation information of the signal receiving node of the first service;
antenna amplitude calibration information of the signal receiving node of the first service;
phase offset calibration information of the signal receiving node of the first service;
timestamp information of obtaining the first measurement value by the signal receiving node of the first service;
time offset calibration information between the signal transmitting node and the signal receiving node of the first service; or
frequency offset calibration information between the signal transmitting node and the signal receiving node of the first service.

In some embodiments, the calibration apparatus 500 further includes:
a first determining module, configured to: in a case in which the first node includes the computing node, determine the sensing result of the first service based on the second measurement value; or
a second sending module, configured to: in a case in which the first node does not include the computing node, send the second measurement value to the computing node, where the computing node is configured to determine the sensing result of the first service based on the second measurement value.

In some embodiments, the first obtaining module 501 is configured to:
receive the first information from a second node, where the second node includes at least one node that is in the signal transmitting node of the first service, the signal receiving node of the first service, and the computing node and that is different from the first node.

In some embodiments, the calibration apparatus 500 further includes:
a third sending module, configured to send third information to the second node, where
the third information includes at least one of the following: the first measurement value, a historical measurement value of a sensing measurement quantity corresponding to the first measurement value, and fourth information, the third information is used to assist the second node in determining the first information, and the fourth information is related to at least one of the following of the signal transmitting node and/or the signal receiving node of the first service: physical state information, hardware information, sensing capability information, and communication capability information.

In some embodiments, the sensing measurement quantity corresponding to the first measurement value includes at least one of the following:
a frequency domain channel response between the signal transmitting node and the signal receiving node of the first service; and
a channel impulse response between the signal transmitting node and the signal receiving node of the first service.

In some embodiments, the physical state information includes at least one of the following:
target state information of the signal receiving node of the first service, where the target state information includes at least one of movement speed information, location information, and antenna array orientation information of the signal receiving node;
target state information of the signal transmitting node of the first service; and
distance information of a target antenna pair, where the target antenna pair includes a transmit antenna of the signal transmitting node of the first service and a receive antenna of the signal receiving node of the first service.

In some embodiments, the fourth information includes at least one of the following:
the sensing capability information of the signal transmitting node of the first service;
the sensing capability information of the signal receiving node of the first service;
the communication capability information of the signal transmitting node of the first service; and
the communication capability information of the signal receiving node of the first service.

In some embodiments, the sensing capability information includes at least one of the following:
maximum bandwidth available for sensing, a time domain resource available for sensing, a frequency domain resource available for sensing, an antenna port resource available for sensing, and a quantity of physical antennas available for sensing, where the antenna port resource available for sensing includes a quantity of antenna ports available for sensing and a mapping relationship between an antenna port and a physical antenna; and/or
the hardware information includes at least one of the following: a quantity of physical antennas, maximum transmit power, a power amplifier gain, power amplifier bandwidth, power amplifier efficiency, power amplifier linearity, maximum output power of a power amplifier, a minimum adjustment step for power control in an analog domain, a minimum adjustment step for power control in a digital domain, a dynamic range of an analog-to-digital converter ADC, a dynamic range of a digital-to-analog converter DAC, and sensing sensitivity; and/or
the communication capability information includes at least one of the following:
maximum bandwidth available for communication, a time domain resource available for communication, a frequency domain resource available for communication, an antenna port resource available for communication, and a quantity of physical antennas available for communication, where the antenna port resource available for communication includes a quantity of antenna ports available for communication and a mapping relationship between an antenna port and a physical antenna.

In some embodiments, the first obtaining module 501 includes:
a measurement unit, configured to: in a case in which the first node includes the signal receiving node of the first service, measure the first signal related to the first service, to obtain the first measurement value; and/or
a first receiving unit, configured to: in a case in which the first node does not include the signal receiving node of the first service, receive the first measurement value from the signal receiving node of the first service.

In some embodiments, the parameter information of the reference path includes at least one of the following:
an amplitude, a phase, a delay, an azimuth angle of departure relative to the signal transmitting node of the first service, an elevation angle of departure relative to the signal transmitting node of the first service, an azimuth angle of arrival relative to the signal receiving node of the first service, and an elevation angle of arrival relative to the signal receiving node of the first service.

In some embodiments, the second information includes at least one of the following:
measurement time offset information, measurement period information, and measurement timestamp information.

In some embodiments, the transmit power control information includes at least one of the following:
a transmit power adjustment value in an analog domain, a transmit power adjustment value in a digital domain, and a control factor used to control transmit power of the first signal related to the first service; and/or
the receive power control information includes at least one of the following:
a receive power adjustment value in the analog domain, a receive power adjustment value in the digital domain, and a control factor used to control receive power of the first signal related to the first service.

In some embodiments, the time offset calibration information between the signal transmitting node and the signal receiving node of the first service includes at least one of the following:
a time calibration value between the signal transmitting node and the signal receiving node of the first service;
channel state information CSI or a channel impulse response phase calibration value indicated by the signal transmitting node of the first service to the signal receiving node of the first service; and
the CSI or a channel impulse response calibration coefficient indicated by the signal transmitting node of the first service to the signal receiving node of the first service.

In some embodiments, the frequency offset calibration information between the signal transmitting node and the signal receiving node of the first service includes at least one of the following:
a frequency calibration value between the signal transmitting node and the signal receiving node of the first service;
CSI or a channel impulse response phase calibration value indicated by the signal transmitting node of the first service to the signal receiving node of the first service; and
the CSI or a channel impulse response calibration coefficient indicated by the signal transmitting node of the first service to the signal receiving node of the first service.

The calibration apparatus provided in this embodiment of this application can implement the processes implemented by the first node in the method embodiment shown in FIG. 2, and achieve same technical effects. To avoid repetition, details are not described herein again.

The information transmission method provided in the embodiments of this application may be performed by an information transmission apparatus. In the embodiments of this application, the information transmission apparatus provided in the embodiments of this application is described by using an example in which the information transmission apparatus performs the information transmission method.

With reference to FIG. 6, an embodiment of this application further provides an information transmission apparatus, applied to a second node. As shown in FIG. 6, the information transmission apparatus 600 includes:
a first sending module 601, configured to send first information to a first node, where the first information is used to indicate a non-ideal factor existing when at least one sensing node executes a first service, the first information is used to calibrate a first measurement value of the first service, the first service includes a sensing service or an integrated sensing and communication service, and the non-ideal factor includes a factor causing at least one of a frequency deviation, a time deviation, a power deviation, an amplitude deviation, and a phase deviation between the first measurement value and a true value.

In some embodiments, the second node includes at least one of the following:
a signal transmitting node, where the signal transmitting node is configured to send a first signal related to the first service;
a signal receiving node, where the signal receiving node is configured to measure the first signal to obtain the first measurement value; and
a computing node, where the computing node is configured to determine a sensing result of the first service based on a second measurement value, and the second measurement value is a measurement value obtained after the first measurement value is calibrated based on the first information; and
the second node is different from the first node.

In some embodiments, the first information includes at least one of the following:
parameter information of at least one reference path in a channel between a signal transmitting node and a signal receiving node of the first service;
a Doppler frequency of at least one reference path in the channel between the signal transmitting node and the signal receiving node of the first service;
first indication information, where the first indication information is used to indicate to perform division processing on a first measurement value obtained through measurement by a first antenna and a first measurement value obtained through measurement by a second antenna, to obtain a first value, the signal receiving node of the first service includes the first antenna and the second antenna, and the second measurement value includes the first value;
first identification information, where in a case in which there is more than one first measurement value, the first identification information indicates a first measurement value used to obtain the parameter information of the at least one reference path;
second information, where the second information includes information related to a time offset between at least two signal receiving nodes of the first service;
transmit power control information of the signal transmitting node of the first service;
in-phase I signal compensation information of the signal transmitting node of the first service;
quadrature Q signal compensation information of the signal transmitting node of the first service;
antenna amplitude calibration information of the signal transmitting node of the first service;
phase offset calibration information of the signal transmitting node of the first service;
receive power control information of the signal receiving node of the first service;
I signal compensation information of the signal receiving node of the first service;
Q signal compensation information of the signal receiving node of the first service;
antenna amplitude calibration information of the signal receiving node of the first service;
phase offset calibration information of the signal receiving node of the first service;
timestamp information of obtaining the first measurement value by the signal receiving node of the first service;
time offset calibration information between the signal transmitting node and the signal receiving node of the first service; and
frequency offset calibration information between the signal transmitting node and the signal receiving node of the first service.

In some embodiments, the information transmission apparatus 600 further includes:
a second obtaining module, configured to obtain third information, where the third information includes at least one of the following: the first measurement value, a historical measurement value of a sensing measurement quantity corresponding to the first measurement value, and fourth information, and the fourth information is related to at least one of the following of the signal transmitting node and/or the signal receiving node of the first service: physical state information, hardware information, sensing capability information, and communication capability information; and
a second determining module, configured to determine the first information based on the third information.

In some embodiments, the sensing measurement quantity corresponding to the first measurement value includes at least one of the following:
a frequency domain channel response between the signal transmitting node and the signal receiving node of the first service; and
a channel impulse response between the signal transmitting node and the signal receiving node of the first service.

In some embodiments, the physical state information includes at least one of the following:
target state information of the signal receiving node of the first service, where the target state information includes at least one of movement speed information, location information, and antenna array orientation information of the signal receiving node;
target state information of the signal transmitting node of the first service; and
distance information of a target antenna pair, where the target antenna pair includes a transmit antenna of the signal transmitting node of the first service and a receive antenna of the signal receiving node of the first service.

In some embodiments, the fourth information includes at least one of the following:
the sensing capability information of the signal transmitting node of the first service;
the sensing capability information of the signal receiving node of the first service;
the communication capability information of the signal transmitting node of the first service; and
the communication capability information of the signal receiving node of the first service.

In some embodiments, the sensing capability information includes at least one of the following:
maximum bandwidth available for sensing, a time domain resource available for sensing, a frequency domain resource available for sensing, an antenna port resource available for sensing, and a quantity of physical antennas available for sensing, where the antenna port resource available for sensing includes a quantity of antenna ports available for sensing and a mapping relationship between an antenna port and a physical antenna; and/or
the hardware information includes at least one of the following: a quantity of physical antennas, maximum transmit power, a power amplifier gain, power amplifier bandwidth, power amplifier efficiency, power amplifier linearity, maximum output power of a power amplifier, a minimum adjustment step for power control in an analog domain, a minimum adjustment step for power control in a digital domain, a dynamic range of an analog-to-digital converter ADC, a dynamic range of a digital-to-analog converter DAC, and sensing sensitivity; and/or
the communication capability information includes at least one of the following:
maximum bandwidth available for communication, a time domain resource available for communication, a frequency domain resource available for communication, an antenna port resource available for communication, and a quantity of physical antennas available for communication, where the antenna port resource available for communication includes a quantity of antenna ports available for communication and a mapping relationship between an antenna port and a physical antenna.

In some embodiments, the information transmission apparatus 600 further includes:
a receiving module, configured to receive the second measurement value from the first node, where the second measurement value is a measurement value obtained after the first measurement value is calibrated based on the first information; and
a third determining module or a fourth sending module, where the third determining module is configured to determine the sensing result of the first service based on the second measurement value, or the fourth sending module sends the second measurement value to the computing node, and the computing node is configured to determine the sensing result of the first service based on the second measurement value.

In some embodiments, in a case in which the second node includes the signal receiving node of the first service, the information transmission apparatus 600 further includes:
a measurement module, configured to measure the first signal related to the first service, to obtain the first measurement value; and
a fifth sending module, configured to send the first measurement value to the first node.

In some embodiments, the parameter information of the reference path includes at least one of the following:
an amplitude, a phase, a delay, an azimuth angle of departure relative to the signal transmitting node of the first service, an elevation angle of departure relative to the signal transmitting node of the first service, an azimuth angle of arrival relative to the signal receiving node of the first service, and an elevation angle of arrival relative to the signal receiving node of the first service.

In some embodiments, the second information includes at least one of the following:
measurement time offset information, measurement period information, and measurement timestamp information.

In some embodiments, the transmit power control information includes at least one of the following:
a transmit power adjustment value in an analog domain, a transmit power adjustment value in a digital domain, and a control factor used to control transmit power of the first signal related to the first service; and/or
the receive power control information includes at least one of the following:
a receive power adjustment value in the analog domain, a receive power adjustment value in the digital domain, and a control factor used to control receive power of the first signal related to the first service.

In some embodiments, the time offset calibration information between the signal transmitting node and the signal receiving node of the first service includes at least one of the following:
a time calibration value between the signal transmitting node and the signal receiving node of the first service;
channel state information CSI or a channel impulse response phase calibration value indicated by the signal transmitting node of the first service to the signal receiving node of the first service; and
the CSI or a channel impulse response calibration coefficient indicated by the signal transmitting node of the first service to the signal receiving node of the first service.

In some embodiments, the frequency offset calibration information between the signal transmitting node and the signal receiving node of the first service includes at least one of the following:
a frequency calibration value between the signal transmitting node and the signal receiving node of the first service;
CSI or a channel impulse response phase calibration value indicated by the signal transmitting node of the first service to the signal receiving node of the first service; and
the CSI or a channel impulse response calibration coefficient indicated by the signal transmitting node of the first service to the signal receiving node of the first service.

The information transmission apparatus provided in this embodiment of this application can implement the processes implemented by the second node in the method embodiment shown in FIG. 4, and achieve same technical effects. To avoid repetition, details are not described herein again.

As shown in FIG. 7, an embodiment of this application further provides a communication device 700, including a processor 701 and a memory 702. The memory 702 stores a program or instructions capable of being run on the processor 701. For example, when the communication device 700 serves as a first node, and the program or the instructions are executed by the processor 701, the steps in the method embodiment shown in FIG. 2 are implemented, and same technical effects can be achieved. When the communication device 700 serves as a second node, and the program or the instructions are executed by the processor 701, the steps in the method embodiment shown in FIG. 4 are implemented, and same technical effects can be achieved. To avoid repetition, details are not described herein again.

An embodiment of this application further provides a communication device, including a processor and a communication interface.

In an implementation, in a case in which the communication device is a first node, the communication interface is configured to: obtain first information, and obtain a first measurement value, where the first information is used to indicate a non-ideal factor existing when at least one sensing node executes a first service, the first service includes a sensing service or an integrated sensing and communication service, and the non-ideal factor includes a factor causing at least one of a frequency deviation, a time deviation, a power deviation, an amplitude deviation, and a phase deviation between the first measurement value and a true value; and the processor is configured to perform calibration processing on the first measurement value based on the first information, to obtain a second measurement value, where a sensing result of the first service is determined based on the second measurement value.

In another implementation, in a case in which the communication device is a second node, the communication interface is configured to send first information to a first node, where the first information is used to indicate a non-ideal factor existing when at least one sensing node executes a first service, the first information is used to calibrate a first measurement value of the first service, the first service includes a sensing service or an integrated sensing and communication service, and the non-ideal factor includes a factor causing at least one of a frequency deviation, a time deviation, a power deviation, an amplitude deviation, and a phase deviation between the first measurement value and a true value.

This embodiment of the communication device corresponds to the foregoing method embodiment. Each implementation process and implementation of the foregoing method embodiment may be applied to this embodiment of the communication device, and same technical effects can be achieved.

An embodiment of this application further provides a readable storage medium. The readable storage medium stores a program or instructions. When the program or the instructions are executed by a processor, the processes in the method embodiment shown in FIG. 2 or FIG. 4 are implemented, and same technical effects can be achieved. To avoid repetition, details are not described herein again.

The processor is a processor in the terminal in the foregoing embodiment. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the method embodiment shown in FIG. 2 or FIG. 4, and same technical effects can be achieved. To avoid repetition, details are not described herein again.

It should be understood that the chip described in this embodiment of this application may also be referred to as a system-on-a-chip, a system chip, a chip system, or the like.

An embodiment of this application further provides a computer program/program product. The computer program/program product is stored in a storage medium. The computer program/program product is executed by at least one processor to implement the processes in the method embodiment shown in FIG. 2 or FIG. 4, and same technical effects can be achieved. To avoid repetition, details are not described herein again.

It should be noted that in this specification, the terms “include”, “comprise”, or any other variants thereof are intended to cover a non-exclusive inclusion, so that a process, a method, an article, or an apparatus that includes a list of elements not only includes those elements but also includes other elements that are not expressly listed, or further includes elements inherent to such a process, method, article, or apparatus. Without more constraints, an element preceded by “includes a . . . ” does not preclude the presence of additional identical elements in the process, method, article, or apparatus that includes the element. In addition, it should be noted that the scope of the method and the apparatus in the implementations of this application is not limited to performing functions in the shown or described sequence, and may further include performing functions in a substantially simultaneous manner or in a reverse sequence based on the functions involved. For example, the described method may be performed in a sequence different from the described sequence, and various steps may be added, omitted, or combined. In addition, features described with reference to some examples may be combined in other examples.

Based on the foregoing descriptions of the implementations, a person skilled in the art may clearly understand that the method in the foregoing embodiments may be implemented by using software and a necessary general-purpose hardware platform, or may be implemented by using hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings. However, this application is not limited to the foregoing specific implementations. The foregoing specific implementations are merely examples, and are not limiting. Many forms that can be made by a person of ordinary skill in the art based on the teachings of this application without departing from the objective and the protection scope of the claims of this application shall fall within the protection scope of this application.

1. A calibration method, comprising:
obtaining, by a first node, first information, and obtaining a first measurement value, wherein the first information is used to indicate a non-ideal factor existing when at least one sensing node executes a first service, the first service comprises a sensing service or an integrated sensing and communication service, and the non-ideal factor comprises a factor causing at least one of a frequency deviation, a time deviation, a power deviation, an amplitude deviation, or a phase deviation between the first measurement value and a true value; and
performing, by the first node, calibration processing on the first measurement value based on the first information, to obtain a second measurement value, wherein a sensing result of the first service is determined based on the second measurement value.

2. The calibration method according to claim 1, wherein the first node comprises at least one of the following:
a signal transmitting node, wherein the signal transmitting node is configured to send a first signal related to the first service;
a signal receiving node, wherein the signal receiving node is configured to measure the first signal to obtain the first measurement value; or
a computing node, wherein the computing node is configured to determine the sensing result of the first service based on the second measurement value.

3. The calibration method according to claim 2, wherein the first information comprises at least one of the following:
parameter information of at least one reference path in a channel between a signal transmitting node and a signal receiving node of the first service;
a Doppler frequency of at least one reference path in the channel between the signal transmitting node and the signal receiving node of the first service;
first indication information, wherein the first indication information is used to indicate to perform division processing on a first measurement value obtained through measurement by a first antenna and a first measurement value obtained through measurement by a second antenna, to obtain a first value, the signal receiving node of the first service comprises the first antenna and the second antenna, and the second measurement value comprises the first value;
first identification information, wherein when there is more than one first measurement value, the first identification information indicates a first measurement value used to obtain the parameter information of the at least one reference path;
second information, wherein the second information comprises information related to a time offset between at least two signal receiving nodes of the first service;
transmit power control information of the signal transmitting node of the first service;
in-phase (I) signal compensation information of the signal transmitting node of the first service;
quadrature (Q) signal compensation information of the signal transmitting node of the first service;
antenna amplitude calibration information of the signal transmitting node of the first service;
phase offset calibration information of the signal transmitting node of the first service;
receive power control information of the signal receiving node of the first service;
I signal compensation information of the signal receiving node of the first service;
Q signal compensation information of the signal receiving node of the first service;
antenna amplitude calibration information of the signal receiving node of the first service;
phase offset calibration information of the signal receiving node of the first service;
timestamp information of obtaining the first measurement value by the signal receiving node of the first service;
time offset calibration information between the signal transmitting node and the signal receiving node of the first service; or
frequency offset calibration information between the signal transmitting node and the signal receiving node of the first service.

4. The calibration method according to claim 3, wherein after the performing, by the first node, calibration processing on the first measurement value based on the first information, to obtain a second measurement value, the calibration method further comprises:
when the first node comprises the computing node, determining, by the first node, the sensing result of the first service based on the second measurement value; or
when the first node does not comprise the computing node, sending, by the first node, the second measurement value to the computing node, wherein the computing node is configured to determine the sensing result of the first service based on the second measurement value.

5. The calibration method according to claim 3, wherein the obtaining, by a first node, first information comprises:
receiving, by the first node, the first information from a second node, wherein the second node comprises at least one node that is in the signal transmitting node of the first service, the signal receiving node of the first service, and the computing node and that is different from the first node.

6. The calibration method according to claim 5, wherein before the receiving, by the first node, the first information from a second node, the calibration method further comprises:
sending, by the first node, third information to the second node,
wherein the third information comprises at least one of the following: the first measurement value, a historical measurement value of a sensing measurement quantity corresponding to the first measurement value, or fourth information, wherein the third information is used to assist the second node in determining the first information, and the fourth information is related to at least one of the following of the signal transmitting node or the signal receiving node of the first service: physical state information, hardware information, sensing capability information, or communication capability information.

7. The calibration method according to claim 6, wherein the sensing measurement quantity corresponding to the first measurement value comprises at least one of the following:
a frequency domain channel response between the signal transmitting node and the signal receiving node of the first service; or
a channel impulse response between the signal transmitting node and the signal receiving node of the first service.

8. The calibration method according to claim 6, wherein the physical state information comprises at least one of the following:
target state information of the signal receiving node of the first service, wherein the target state information comprises at least one of movement speed information, location information, or antenna array orientation information of the signal receiving node;
target state information of the signal transmitting node of the first service; or
distance information of a target antenna pair, wherein the target antenna pair comprises a transmit antenna of the signal transmitting node of the first service and a receive antenna of the signal receiving node of the first service.

9. The calibration method according to claim 6, wherein the fourth information comprises at least one of the following:
the sensing capability information of the signal transmitting node of the first service;
the sensing capability information of the signal receiving node of the first service;
the communication capability information of the signal transmitting node of the first service; or
the communication capability information of the signal receiving node of the first service.

10. The calibration method according to claim 9, wherein the sensing capability information comprises at least one of the following:
maximum bandwidth available for sensing, a time domain resource available for sensing, a frequency domain resource available for sensing, an antenna port resource available for sensing, and a quantity of physical antennas available for sensing, wherein the antenna port resource available for sensing comprises a quantity of antenna ports available for sensing and a mapping relationship between an antenna port and a physical antenna; or
the hardware information comprises at least one of the following: a quantity of physical antennas, maximum transmit power, a power amplifier gain, power amplifier bandwidth, power amplifier efficiency, power amplifier linearity, maximum output power of a power amplifier, a minimum adjustment step for power control in an analog domain, a minimum adjustment step for power control in a digital domain, a dynamic range of an analog-to-digital converter (ADC), a dynamic range of a digital-to-analog converter (DAC), or sensing sensitivity; or
the communication capability information comprises at least one of the following:
maximum bandwidth available for communication, a time domain resource available for communication, a frequency domain resource available for communication, an antenna port resource available for communication, or a quantity of physical antennas available for communication, wherein the antenna port resource available for communication comprises a quantity of antenna ports available for communication and a mapping relationship between an antenna port and a physical antenna.

11. The calibration method according to claim 1, wherein the obtaining, by a first node, a first measurement value comprises:
when the first node comprises the signal receiving node of the first service, measuring, by the first node, the first signal related to the first service, to obtain the first measurement value; or
when the first node does not comprise the signal receiving node of the first service, receiving, by the first node, the first measurement value from the signal receiving node of the first service.

12. The calibration method according to claim 3, wherein the parameter information of the reference path comprises at least one of the following:
an amplitude, a phase, a delay, an azimuth angle of departure relative to the signal transmitting node of the first service, an elevation angle of departure relative to the signal transmitting node of the first service, an azimuth angle of arrival relative to the signal receiving node of the first service, or an elevation angle of arrival relative to the signal receiving node of the first service.

13. The calibration method according to claim 3, wherein the second information comprises at least one of the following:
measurement time offset information, measurement period information, or measurement timestamp information.

14. The calibration method according to claim 3, wherein the transmit power control information comprises at least one of the following:
a transmit power adjustment value in an analog domain, a transmit power adjustment value in a digital domain, or a control factor used to control transmit power of the first signal related to the first service; or
the receive power control information comprises at least one of the following:
a receive power adjustment value in the analog domain, a receive power adjustment value in the digital domain, or a control factor used to control receive power of the first signal related to the first service.

15. The calibration method according to claim 3, wherein the time offset calibration information between the signal transmitting node and the signal receiving node of the first service comprises at least one of the following:
a time calibration value between the signal transmitting node and the signal receiving node of the first service;
channel state information (CSI) or a channel impulse response phase calibration value indicated by the signal transmitting node of the first service to the signal receiving node of the first service; or
the CSI or a channel impulse response calibration coefficient indicated by the signal transmitting node of the first service to the signal receiving node of the first service.

16. The calibration method according to claim 3, wherein the frequency offset calibration information between the signal transmitting node and the signal receiving node of the first service comprises at least one of the following:
a frequency calibration value between the signal transmitting node and the signal receiving node of the first service;
CSI or a channel impulse response phase calibration value indicated by the signal transmitting node of the first service to the signal receiving node of the first service; or
the CSI or a channel impulse response calibration coefficient indicated by the signal transmitting node of the first service to the signal receiving node of the first service.

17. A communication device, comprising: a memory storing a computer program; and a processor coupled to the memory and configured to execute the computer program to perform operations comprising:
obtaining first information and a first measurement value, wherein the first information is used to indicate a non-ideal factor existing when at least one sensing node executes a first service, the first service comprises a sensing service or an integrated sensing and communication service, and the non-ideal factor comprises a factor causing at least one of a frequency deviation, a time deviation, a power deviation, an amplitude deviation, or a phase deviation between the first measurement value and a true value; and
performing calibration processing on the first measurement value based on the first information, to obtain a second measurement value, wherein a sensing result of the first service is determined based on the second measurement value.

18. The communication device according to claim 17, further comprising at least one of the following:
a signal transmitting node, wherein the signal transmitting node is configured to send a first signal related to the first service;
a signal receiving node, wherein the signal receiving node is configured to measure the first signal to obtain the first measurement value; or
a computing node, wherein the computing node is configured to determine the sensing result of the first service based on the second measurement value.

19. The communication device according to claim 18, wherein the first information comprises at least one of the following:
parameter information of at least one reference path in a channel between a signal transmitting node and a signal receiving node of the first service;
a Doppler frequency of at least one reference path in the channel between the signal transmitting node and the signal receiving node of the first service;
first indication information, wherein the first indication information is used to indicate to perform division processing on a first measurement value obtained through measurement by a first antenna and a first measurement value obtained through measurement by a second antenna, to obtain a first value, the signal receiving node of the first service comprises the first antenna and the second antenna, and the second measurement value comprises the first value;
first identification information, wherein when there is more than one first measurement value, the first identification information indicates a first measurement value used to obtain the parameter information of the at least one reference path;
second information, wherein the second information comprises information related to a time offset between at least two signal receiving nodes of the first service;
transmit power control information of the signal transmitting node of the first service;
in-phase (I) signal compensation information of the signal transmitting node of the first service;
quadrature (Q) signal compensation information of the signal transmitting node of the first service;
antenna amplitude calibration information of the signal transmitting node of the first service;
phase offset calibration information of the signal transmitting node of the first service;
receive power control information of the signal receiving node of the first service;
I signal compensation information of the signal receiving node of the first service;
Q signal compensation information of the signal receiving node of the first service;
antenna amplitude calibration information of the signal receiving node of the first service;
phase offset calibration information of the signal receiving node of the first service;
timestamp information of obtaining the first measurement value by the signal receiving node of the first service;
time offset calibration information between the signal transmitting node and the signal receiving node of the first service; or
frequency offset calibration information between the signal transmitting node and the signal receiving node of the first service.

20. A non-transitory computer-readable storage medium, storing a computer program, wherein the computer program, when executed by a processor, causes the processor to perform operations comprising:
obtaining, by a first node, first information, and obtaining a first measurement value, wherein the first information is used to indicate a non-ideal factor existing when at least one sensing node executes a first service, the first service comprises a sensing service or an integrated sensing and communication service, and the non-ideal factor comprises a factor causing at least one of a frequency deviation, a time deviation, a power deviation, an amplitude deviation, or a phase deviation between the first measurement value and a true value; and
performing, by the first node, calibration processing on the first measurement value based on the first information, to obtain a second measurement value, wherein a sensing result of the first service is determined based on the second measurement value.
